(19) United States
(12) Patent Application Publication
(10) Pub. No.: US 2024/0170977 A1
(43) Pub. Date: May 23, 2024

(54) ACTIVE CELL BALANCING IN BATTERIES USING SWITCH MODE DIVIDERS

(71) Applicant: Eric Paul Grasshoff, San Marcos, CA (US)

(72) Inventor: Eric Paul Grasshoff, San Marcos, CA (US)

(21) Appl. No.: 18/520,801

(22) Filed: Nov. 28, 2023

Related U.S. Application Data
(63) Continuation-in-part of application No. 17/750,238, filed on May 20, 2022.
Application No. 17/750,238 is a continuation-in-part of application No. 17/146,787, filed on Jan. 12, 2021, now Pat. No. 11,876,394.
Application No. 17/146,787 is a continuation-in-part of application No. 15/961,604, filed on Apr. 24, 2018, now Pat. No. 10,910,847.

(51) Int. Cl. H02J 7/00

(52) U.S. Cl. CPC H02J 7/0019; H02J 7/0047; H02J 7/007182

(57) ABSTRACT

A battery cell balancing system contains a switch mode circuit employing voltage sensors across the cells and current sensors on the balancing legs to enable reliable and efficient cell balancing during battery charge.

### CROSS-REFERENCE TO RELATED APPLICATIONS

This application claims the benefit of U.S. Utility patent application Ser. No. 17/750,238 filed on May 20, 2022, which claims priority from U.S. Utility patent application Ser. No. 17/146,787 filed on Jan. 12, 2021, which claims priority to U.S. Utility patent application Ser. No. 15/961,604 filed Apr. 24, 2018 and issued on Feb. 2, 2021 as U.S. Pat. No. 10,910,847, which claims priority from U.S. Provisional Patent Application No. 62/658,364 filed Apr. 16, 2018 and U.S. Provisional Patent Application No. 62/609,063 filed Dec. 21, 2017, all of which are incorporated by reference herein in their entirety.

### FIELD OF THE INVENTION

The application relates generally to balancing battery cells during charging or discharging.

### BACKGROUND

A battery is a device that stores electrical energy. The energy that is stored in a battery can provide electrical power to a wide range of devices, such as flashlights or electric motors or computers. When a battery is powering a device, the level of energy in the battery drops. At some point, the level of energy in the battery will drop to a point where it can no longer provide power to the device. Some batteries are rechargeable, meaning that electrical energy can be put back into the battery—similar to refilling a gas tank in a car. A battery charger puts energy back into the battery, and the battery can be used again and again to power a device.

Batteries are comprised of cells. A battery can be comprised of just one cell, or it can have multiple cells that are connected.

Cells can be connected in series to increase the voltage of the battery. This is done by connecting the positive terminal of one cell to the negative terminal of another cell. When several batteries (or cells) are installed in a flashlight, they are usually connected in series.

Cells can also be connected in parallel to increase the capacity of the battery. When cells are connected in parallel, all of the positive terminals are connected together, and all of the negative terminals are connected together. A group of cells connected in parallel is essentially equivalent to one big cell.

Cells that are connected in parallel can also be connected in series to make a battery that has a higher voltage and a greater capacity than a battery that utilizes a single cell.

When batteries are used, they degrade. As they degrade, the capacity of the battery decreases. (This is comparable to a gas tank getting smaller.) Eventually every battery will die, meaning its capacity has degraded to a point where it is no longer effective at providing power to the device it is connected to. Colloquially, this is called a “dead battery”.

Batteries can also lose capacity due to a condition called “out-of-balance”. This can happen to batteries that consist of multiple cells connected in series. The battery may have single cells connected in series; or it may have groups of cells in parallel that are connected in series. Either type of battery architecture can get out of balance.

If all the cells in a battery are exactly identical, it will not get out of balance. This would be a perfect battery. However, it is impossible to make a perfect battery. There are inherent variations in cell characteristics, such as the capacity of each cell (i.e., how much electrical energy each cell can store).

Out-of-balance is a particular problem for rechargeable batteries, because if a battery is just a bit out-of-balance, it will become increasingly out-of-balance on each subsequent cycle of discharging and then recharging. Lithium-ion batteries (and many other modern batteries) are very susceptible to getting out-of-balance because of their electrical characteristics.

Therefore, many modern rechargeable batteries include a “balancing” technology to try to correct and compensate for out-of-balance conditions. The most common kind of balancing technology is called passive balancing. Passive balancing systems can only compensate for very minor variations in cell characteristics.

As batteries age, variations in cell characteristics tend to increase, and at some point, the battery may be in a condition that passive balancing systems cannot compensate for. At that point, the battery will start to lose capacity at an increasingly rapid rate and will reach end of life prematurely.

Therefore, there is a need for a balancing technology that can efficiently and effectively compensate for variations in cell characteristics that are greater than passive balancing systems can compensate for.

### SUMMARY

To resolve the problems inherent in the prior art an assembly includes at least one switch mode divider (SMD) connectable in parallel to at least one respective battery cell and operable to equalize voltages between a plurality of battery cells, the SMD being characterized by an output voltage Vo that is a function of a duty cycle of a drive waveform and high and low rail voltages. An embodiment of the invention includes at least one circuit that generates a signal representative of current on a balancing leg to enable the SMD to limit balancing current to at least one of the cells during balancing.

In one or more embodiments of the invention, the circuit comprises a current sensor that generates the signal based on current sensed by the current sensor.

In one or more embodiments of the invention disclosed herein, the circuit comprises a controller that generates the signal based on an estimation of current.

In a system embodying one or more aspects of the invention an apparatus includes at least first and second battery cells arranged in electrical series with each other and defining a primary charge/discharge path. The cells connected in series include a positive terminal node, a negative terminal node and at least one node at a junction between two cells connected in series. A balancing circuit is arranged in electrical parallel with the primary charge/discharge path. The balancing circuit includes a voltage sensor line that includes at least one voltage sensor. The apparatus further includes a respective switch mode divider (SMD) connected to a respective cell junction. At least one controller controls the respective SMDs to equalize voltages between battery cells.

A method implementing one or more aspects of the invention includes modulating at least one switch mode divider (SMD) associated with respective battery cells to equalize voltage between the battery cells. The SMD is characterized by being driven by a constant period signal having an ON time and OFF time, the sum of which equals a total constant period. The method further includes limiting current in at least one balancing leg associated with at least one SMD to satisfy a threshold. The threshold specifies the maximum magnitude of current that can pass through the balancing leg in either direction (positive or negative current).

In one or more embodiments of the invention, an assembly includes at least one switch mode divider (SMD) connectable to the junction between two battery cells connected in series and operable to equalize voltages between said cells. At least one current sensor is associated with a balancing leg to enable the SMD to limit balancing current to at least one cell during charging.

The SMDs may consist of two switches and an inductor. The switches in the SMDs may be field effect transistors (FETs).

Balancing current is limited in one or more embodiments of the invention to not exceed a threshold by characterization of impedance of the balancing circuit.

Balancing current may also be limited to not exceed a threshold by controlling or limiting the range of the duty cycle of the pulse width modulated (PWM) control signal input to the SMD.

In one or more embodiments of the invention, the PWM control signal drive circuit includes capacitor coupling with rectifier DC restoration.

In one or more embodiments of the invention, impedances of the cells in the series stack may be calculated using data obtained from voltage sensors connected in parallel to each cell and from current sensors in the balancing circuit.

Impedances of the cells in the series stack may also be calculated using a current signal generator (CSG).

Biasing lines containing bias resistors may be part of the system to reduce the possibility of damaging the circuit while connecting the system to a battery.

A method implementing one or more aspects of the invention includes modulating plural switch mode dividers (SMDs) associated with respective cells to equalize voltage between the cells during battery charge or discharge or while the battery is idle. The method further includes limiting current in at least one balancing leg associated with at least one SMD to satisfy a threshold.

The details of one or more embodiments of the invention, both as to its structure and operation, can best be understood in reference to the accompanying drawings and detailed description set forth herein. The claims however and the full scope of any equivalents when assigned their ordinary meaning to one of ordinary skill in the art are what define the scope of the invention.

Benefits of One or More Embodiments

The battery management system disclosed herein enables significant improvements in the performance and function of batteries; in particular, batteries with low internal impedance such as lithium-ion batteries. Key areas of improved performance of one or more embodiments of the invention are described herein for context of the benefits the technology may provide.

One particular benefit of the inventive balancing technology to be described herein is batteries using this improved balancing technology will lose capacity at a slower rate and have a longer life.

Aspects of the invention complete the equivalent of a CCCV charge cycle on every cell in the battery, regardless of age of the battery and regardless of variations in cell characteristics (such as capacity, SOC, internal impedance and self-discharge rate). Cell characteristics inevitably drift and vary over time and use. These variations in characteristics can grow quite wide in batteries that experience frequent use, such as in electric vehicles, and can make it difficult to balance the battery.

Prior balancing technologies have limited balancing performance and may take many hours or even several days to balance a battery with wide variations in cell characteristics. The most commonly used balancing technology (passive balancing) tries to balance the battery by draining energy out of cells and diverting the energy to load resistors where it is converted to heat, which adds stress to the battery and to system electronics. Passive balancing may be considered 100% inefficient, because 100% of the balancing energy is removed from the battery. And passive balancing is necessarily slow; the balancing current must be limited (typically to 100 mA to 200 mA) to limit the amount of heat that is generated.

In contrast, one or more embodiments of the invention set forth herein can balance batteries quickly and efficiently. This is achieved by moving energy from the primary charge path (or from higher SOC cells) to lower SOC cells. The efficiency of each balancing loop is typically greater than 95%, which means that very little of the balancing energy is dissipated as heat. This enables much greater balancing currents. In a typical battery in an electric vehicle, for example, balancing current can be between 2 A and 10 A. This is between 10 and 100 times greater than the balancing current in a typical passive balancing system. This allows one or more embodiments of the invention to complete balancing between 10 and 100 times more quickly than passive balancing.

Additionally, one or more embodiments of the invention can balance during discharge. This allows energy to be moved from higher SOC cells to lower SOC cells during discharge, which enables more complete utilization of the energy stored in the battery. Passive balancing systems cannot balance during discharge, so when the weakest cell reaches the low voltage cut-off, the battery must be disconnected from the load and must be recharged before it can be used again. But when the weakest cell reaches cut-off voltage, every other cell in the battery still has energy that could be used—except for the fact that passive balancing systems have no way to access that energy. By balancing during discharge, one or more embodiments of the invention can access most of that additional energy in the battery which can, for example, significantly extend the driving range of an electric vehicle.

An additional performance benefit that embodiments of the invention provide is maximization of battery life. As batteries age and cell characteristics drift, the battery eventually will get out of balance to a point that current passive balancing systems cannot bring the battery back into balance. When that happens, the battery quickly accelerates into increasingly out-of-balance conditions, which shortens the life of the battery. One or more embodiments of the invention eliminate out-of-balance conditions for the entire life of the battery, regardless of variations in cell conditions. This can extend battery life by an estimated 20% to 30% in tier-1 batteries, and by as much as 100% in tier-2 batteries.

Another benefit one or more embodiments of the invention provide is that it enables measurement of impedance on a cell-by-cell basis while the battery is installed in a product (such as an electric vehicle) and while the battery is charging, discharging or idle. One or more embodiments of the invention enable measurement of DC resistance and AC impedance at frequencies that typically range from 1 Hz up to 10 kHz (or more), and one or more embodiments of the invention enable measurement of static impedance and dynamic impedance (the first derivative of static impedance). Having the ability to measure these forms of impedance provides insight into the health and aging of the cells in the battery. Existing (or prior) balancing technology is not able to measure all of these forms of impedance on a cell-by-cell basis. As noted above, in the context of this description of the invention a set of cells connected in parallel is treated as a single cell.

These features of one or more embodiments of the invention provide benefits to many industries that work with or use batteries. As examples, two industries that would benefit from one or more embodiments of the invention are manufacturers of electric vehicles and manufacturers of the batteries that go into electric vehicles.

Benefits to Electric Vehicles

By integrating one or more embodiments of the invention into electric vehicles, manufacturers of the vehicles will enjoy benefits such as an ability to have longer vehicle range, because more energy is stored in the battery during charge, and more of that stored energy can be delivered to the vehicle's motor(s) while the vehicle is being driven. Electric vehicles would also decrease the loss of driving range over the life of the vehicle, because loss of range due to out-of-balance conditions is reduced or eliminated. Vehicles implementing one or more embodiments of the invention would have an increase in the life of the vehicle, because battery life is increased. The system may also be able to provide early warnings to the driver of cells that are going bad as indicated by unusual changes in cell impedance. This can be the difference between a preventive maintenance procedure and the driver being stranded on the side of the road with a bad battery.

### Benefits to Battery Manufactures

By integrating one or more embodiments of the invention into their batteries, battery manufacturers will enjoy having a technology where cells don't need to be so closely matched when batteries are assembled, because one or more embodiments of the invention compensate for variations in cell characteristics. This can lower manufacturing costs and reduce manufacturing scrap rates. One or more embodiments of the invention enable a manufacturer's tier-2 batteries to perform similarly to present tier-1 batteries that use passive balancing. Similarly, tier-3 batteries using one or more embodiments of the invention can perform similarly to tier-2 batteries that have passive balancing. Additionally, batteries will have a greater average capacity over the life of the battery. One or more embodiments of the invention increases the average lifetime capacity of the battery. Phrased another way, by removing passive balancing from a battery and installing one or more embodiments of invention, the battery effectively becomes bigger (in terms of available capacity).

Another benefit is that battery manufacturers will be able to get real-time data on cell impedance from batteries that are in the field, being used in real-world conditions. The ability of one or more embodiments of the invention to obtain data on cell impedance provides valuable data on how cells age and decay in real-world use environment, which in turn will allow battery manufactures to detect defects, improve production processes and develop improved battery technologies.

### BRIEF DESCRIPTION OF THE DRAWINGS

FIG. 1 is a block diagram of an example system consistent with present principles in accordance with one or more embodiments of the invention;

FIG. 2 is a diagram of a switch mode divider (SMD) in accordance with one or more embodiments of the invention;

FIG. 3 is a diagram of a switch mode divider with FETs as the switches in accordance with one or more embodiments of the invention;

FIG. 4 is a diagram of a circuit for balancing cell voltage in accordance with one or more embodiments of the invention;

FIG. 5 is a flow chart of example logic according to an example embodiment of the invention;

FIG. 6 is a diagram of a circuit for balancing cell voltage of a battery with multiple cells in series without using hardware current sensors configured in accordance with one or more embodiments of the invention;

FIG. 7 is another diagram of a circuit for balancing cell voltage of a battery with multiple cells in series without using hardware current sensors configured in accordance with one or more embodiments of the invention;

FIG. 8 is a flow chart of example logic of wideband impedance measurement according to an example embodiment of the invention;

FIG. 9 is an illustration of a voltage waveform that is generated by a cell impedance measurement method showing examples of time intervals for measuring voltage and current values in accordance with one or more embodiments of the invention;

FIG. 10 is a flow chart of example logic of narrowband impedance measurement according to an example embodiment of the invention;

FIG. 11 is a plot of an unfiltered waveform that may be generated during cell impedance measurement in accordance with one or more embodiments of the invention;

FIG. 12 is a plot of a waveform after filtering in accordance with one or more embodiments of the invention;

FIG. 13 is a circuit drawing of an SMD with FETs and with capacitor coupling and DC rectifier restoration in accordance with one or more embodiments of the invention;

FIG. 14 is a flowchart showing process steps associated with PWM current limiting; FIG. 14A is a flowchart showing steps associated with calculating PWMnull; FIG. 14B is a flowchart showing steps associated with measuring cell voltages with a positive reference current; FIG. 14C is a flowchart showing steps associated with measuring cell voltages with a negative reference current; FIG. 14D is a flowchart showing steps associated with determining the value of PWM+ for each SMD; and FIG. 14E is a flowchart showing steps associated with determining the value of PWM− for each SMD;

FIG. 15 is a block diagram of DC resistance measurement using a current signal generator (CSG) in accordance with one or more embodiments of the invention.

FIG. 16 is a block diagram of AC impedance measurement using a current signal generator (CSG) in accordance with one or more embodiments of the invention;

FIG. 17 is a flowchart showing how to calculate DC resistance using a CSG in accordance with one or more embodiments of the invention;

FIG. 18 is a flowchart showing how to calculate AC impedance using a CSG in accordance with one or more embodiments of the invention;

FIG. 19 is a circuit drawing showing bias lines and bias resistors added to the balancing circuit in accordance with one or more embodiments of the invention;

FIG. 20 is a block diagram of an example system consistent with present principles that includes a current signal generator (CSG) in accordance with one or more embodiments of the invention; and

FIG. 21 is a diagram of a circuit that illustrates a single PWM generator that can simultaneously generate a plurality of independent PWM control signals for a plurality of SMDs in accordance with one or more embodiments of the invention.

### DETAILED DESCRIPTION OF THE INVENTION

This disclosure relates generally to managing the states of charge (SOCs) of cells in batteries and has particular relevance to managing the SOCs of cells in rechargeable batteries that use cells that have low impedance, one example of which is Lithium-ion batteries. A system herein may include batteries, components powered by the batteries, and battery management assemblies that may include one or more computing components to control charging, discharging and/or balancing. Battery management assemblies may include one or more processors executing instructions that configure the assemblies to control the SOCs of the cells consistent with present principles. As used herein, instructions refer to computer-implemented methods for processing information in the system. Instructions can be implemented in software, firmware or hardware or any combinations thereof and include any type of programmed action undertaken by components of the system.

A processor may be any conventional general-purpose single-chip or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof, hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device, or an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optic and coaxial wires and digital subscriber line (DSL) and twisted pair wires.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The following terms may be used herein:

Battery Capacity—the amount of energy available in a battery, typically expressed in Amp-hours (Ah) or Watt-hours (Wh).

Cell—is an electrical energy storage unit, typically consisting of an anode, a cathode, an electrolyte, and a separator. A battery can consist of a single cell, or many cells connected in series and/or in parallel. In the context of balancing a battery, a group of cells connected in parallel is treated as a single large cell.

State of Charge (SOC)—the amount of energy available in a cell or battery at any given moment, typically stated as a percent of Full Battery Capacity (FBC).

State of Health (SOH)—an indication of the present Full Battery Capacity (FBC) of a battery relative to the battery's Nominal Battery Capacity when it was new. For example, if the nominal capacity of a battery (when new) is 200 Ah, and after some period of use the FBC drops to 160 Ah, then the SOH of the battery is 80%.

Primary Charge Path—refers to an electrically conductive path straight down the series of battery cells that can be used to charge or discharge the battery.

Balance—A battery is balanced when, at the terminal stage of charging, the cell voltages have been equalized in which every cell (where “cell” can be a group of individual cells connected in parallel) is at Full Charge Voltage and charging has typically continued thereafter until the balancing current has dropped to a threshold low level as further explained below, at which point the battery is balanced.

Equalize—is used to describe the process of reducing differences in cell voltages during the balancing process with a goal of bringing a battery into balance.

Note that “balanced” and “out of balance” are relative terms. For present purposes, a battery is considered balanced if the SOCs of all the cells in the battery are within approximately ±1% of each other.

Balancing Current—refers to the differences in charge (or discharge) current applied to a subset of the cells in the battery to attempt to bring the cells into balance.

Balancing Leg—refers to a conductive path that is off the Primary Charge Path and that is used for applying charge or discharge currents to a subset of cells in an attempt to balance the battery.

True Battery Capacity—is the capacity of a battery when every cell in the battery is charged to 100% SOC.

Available Battery Capacity—the capacity of a battery at any given instant. Nominal Battery Capacity—refers to nominal capacity of a battery when new.

Full Battery Capacity—refers to the available capacity in the battery after the battery management system has charged the battery as fully as the battery management system is capable of.

True Battery Capacity vs. Full Battery Capacity—If a charging system cannot or does not bring every cell up to 100% State of Charge, (SOC) at the end of a charge cycle, then Full Battery Capacity will be less than True Battery Capacity.

Cell Voltage—the voltage of a cell at any instant.

Nominal Voltage—the average or mean voltage of a cell or battery over the flat region of the discharge curve.

Full Charge Voltage—the voltage which a cell or battery is brought to at the end of a charging cycle.

Cell Impedance—refers to cell voltage divided by cell current.

Dynamic Impedance—the first derivative of the voltage with respect to current −dV/dI.

Switch Mode Divider (SMD)—is a voltage divider circuit that uses switch mode architecture. Other commonly used terms for such a circuit are “buck converter with synchronous rectifier” or “buck converter using half-bridge driver” or “half-H”.

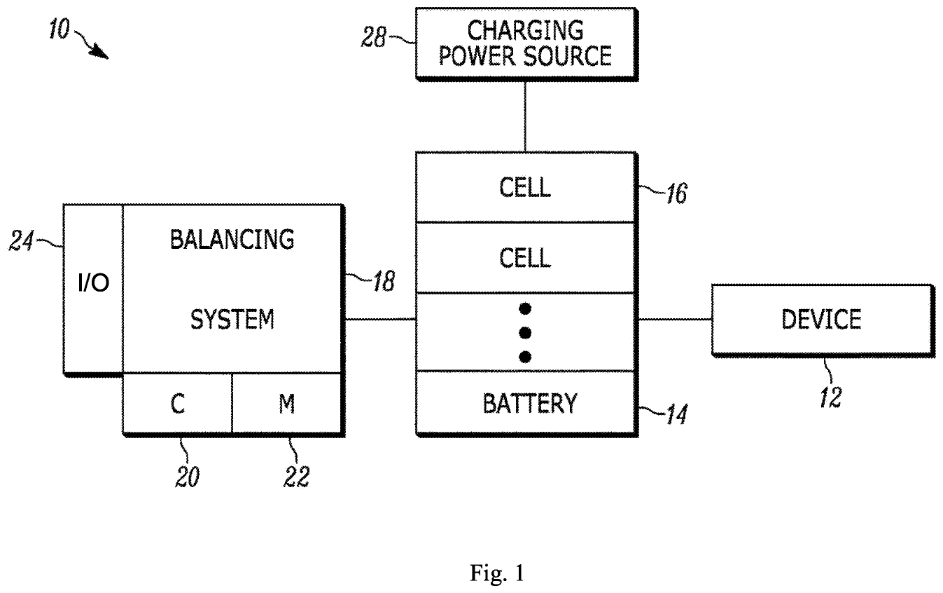

Now specifically referring to FIG. 1, an example system 10 is shown, which may include one or more of the example devices mentioned above and described further below in accordance with present principles. The first of the example devices included in system 10 is device 12, which is any device able to make use of rechargeable battery 14. Device 12 may, for example, be the motors in an electric vehicle, or the electrical system in a house or commercial building, or an electric power grid.

The device 12 may be powered by a rechargeable battery 14, such as a Lithium-ion battery with plural cells 16 connected in electrical series, it being understood that while only a single connection is shown between the battery 14 and device 12, more than one electrical line typically connects the battery to the device. The battery 14 may be removably or non-removably coupled to the device 12. A Lithium-ion battery may be implemented by any battery that uses lithium, including batteries that use cathodes with chemistries such as Lithium Iron Phosphate, Lithium Cobalt Oxide, Lithium Nickel Manganese Cobalt Oxide, Lithium Manganese Oxide, Lithium Nickel Cobalt Aluminum Oxide, Lithium Titanate, or any other battery chemistry that uses lithium ions. While use in connection with Li-ion batteries is an example usage contemplated herein, the principals and ideas set forth herein are useful with any appropriate source of stored energy or energy storage element, in particular (though not exclusively) those that exhibit a low impedance characteristic during charge/discharge.

As discussed further below, a balancing system 18 can be electrically connected to the battery 14. The balancing system 18 can be incorporated all or in part within the housing of the device 12 or it may be separate therefrom. The balancing system 18 can be enclosed inside the battery case or it can be disposed outside the battery case.

Among the components of the balancing system 18 that are more fully disclosed below are at least one controller 20 and at least one data storage medium 22. The data memory 22 may be, without limitation, disk-based or solid-state storage that is not a transitory signal. The memory 22 may be removable media or any other means of suitable data storage.

The balancing system 18 may also include one or more input/output interfaces 24 such as CANbus, universal serial bus (USB) port, Internet, a wide area or local area network, a Wi-Fi network, a wireless telephony network, a Bluetooth network, or any other transmission mechanism able to act as a suitable input/output interface.

As discussed further below, the balancing system 18 acts to equalize the voltages of the individual cells 16 during charging from a charging power source 28, or during battery discharge, or while the battery 14 is idle (not charging or discharging).

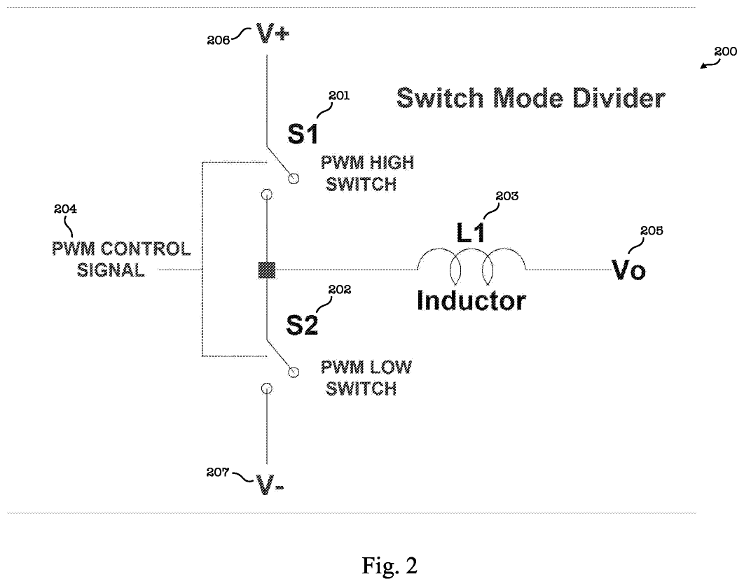

FIG. 2 illustrates an example of a switch mode divider (SMD) 200. In this example the SMD 200 utilizes a high switch (S1) 201, a low switch (S2) 202, an inductor (L1) 203, a pulse width modulated control signal 204 that alternately and complimentarily opens and closes S1 201 and S2 202, an output voltage (Vo) 205 that can be at any voltage between the high rail voltage (V+) 206 and the low rail voltage (V−) 207. The voltage of Vo 205 is determined by the duty cycle of the pulse width modulated control signal 204 as is described in more detail below.

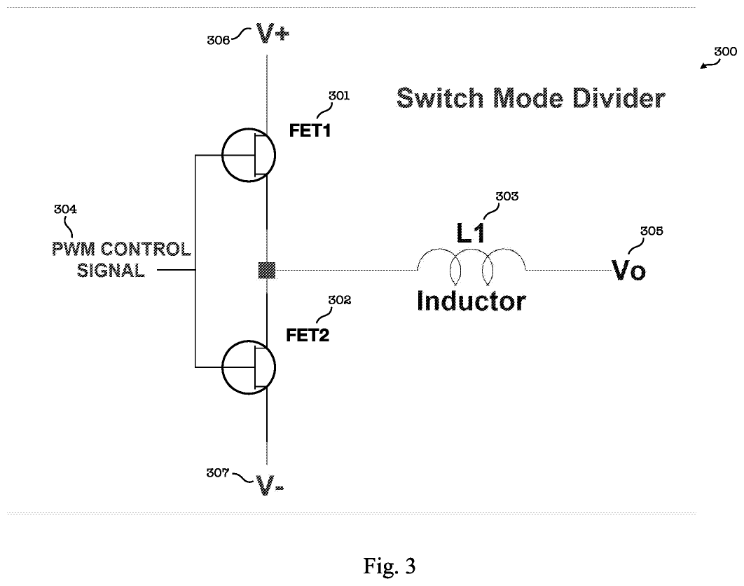

FIG. 3 illustrates another example of an SMD 300 that uses field effect transistors (FETs) as switches—specifically as the high switch (FET1) 301 and the low switch (FET2) 302. Switch types other than FETs may be utilized in accordance with one or more embodiments of the invention in instances where such is suitable for the desired implementation.

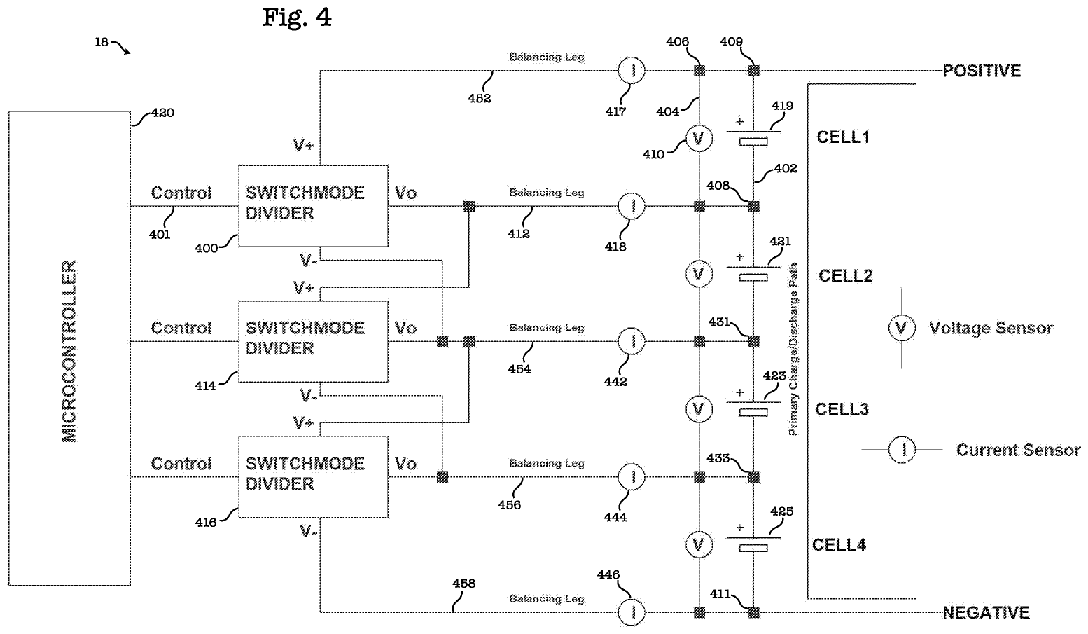

Turning now to FIG. 4 for a more detailed depiction of an example balancing system 18, the balancing system 18 includes plural switch mode dividers (SMDs) 400, 414 and 416. As understood herein, a balancing system that uses SMDs can overcome limitations of less efficient balancing systems. The low impedance current paths of SMDs provide higher efficiency at moving energy to balance cells in the battery as compared to balancing technologies which do not employ switch mode dividers. But the low impedance of SMDs results in a control system with high loop gain, rendering the control loop very sensitive to even the most modest differences in voltages of the cells 16.

Speaking generally of control systems with high-gain loops: Such systems, if not effectively controlled, can result in excessive currents on the balancing legs, which could damage the control electronics and/or the battery. Therefore, it is desirable to have a means of limiting current in order to prevent runaway current conditions. This can be achieved with the use of current sensors on the high-gain loops. Additionally, a threshold value may be set for current on the high-gain loops. Such a system may be designed so that current on the high-gain loops does not exceed the threshold, thereby preventing excessive balancing currents that could damage the system. This concept is now described in further detail in the context of one or more embodiments of the invention.

Current sensors 417, 418, 442, 444 and 446 in the below-described balancing legs 412, 454 and 456 of the balancing system 18 are used to determine whether current in the balancing legs 412, 454 and 456 is within a threshold range that is specified by the below-described threshold(s) for the balancing system 18. This current measurement enables the balancing system 18 to limit the loop gain of the circuit, resulting in more effective control of the high-gain loop.

In general, and prior to describing the details of the balancing system 18, SMDs are high power (low impedance) voltage dividers as illustrated in FIG. 2, which shows an example of an SMD. The output voltage Vo 205 of an SMD 200 is a function of the duty cycle of a pulse width modulated (PWM) control signal 204 that controls the open or closed state of switches S1 201 and S2 202. When S1 201 is closed, it connects high rail voltage V+ 206 to inductor L1 203. When S2 202 is closed, it connects low rail voltage V− 207 to inductor L1 203.

In accordance with switch-mode circuit techniques, an SMD 200 is driven by a constant period signal having a unique ON time and OFF time, the sum of which two times is essentially equal to a total constant period. SMD modulation takes the form of Pulse Width Modulation (PWM) in that the ratio of ON time to total period (also defined as duty cycle) is adjusted to vary the output voltage Vo 205 in direct correspondence. If the duty cycle is 50%, the output voltage Vo 205 will be at (or very near) the midpoint between V+ 206 and V− 207. If the duty cycle is 100%, the output voltage Vo 205 will be equal (or nearly equal) to V+ 206. If the duty cycle is 0%, the output voltage Vo 205 will be equal (or nearly equal) to V− 207.

The low impedance of the SMD-based balancing system 18 allows relatively large balancing current levels to be applied to the cells 419, 421, 423, 425 at very high efficiency. Because SMDs 400, 414, 416 and cells 419, 421, 423, 425 are typically very low impedance devices which are essentially connected in parallel in system 18, a very small change in the duty cycle, creating a small voltage difference, produces a relatively high corresponding level of differential balancing current. When changing the voltage that is applied to low impedance cells to charge and/or balance them, the resulting high-gain response can create feedback instability for the balancing system 18, a problem that is addressed by use of current sensors in the balancing legs 452, 412, 454, 456, 458 as described below.

FIG. 3 illustrates an embodiment of an SMD 300 in which the switches are FETS 301 and 302. FETs may be employed as the switches because FETs are available with high current ratings, which may be desirable in some applications of this system 18.

Returning to FIG. 4, plural battery cells 419, 421, 423, 425 are arranged in electrical series with each other as shown to define a primary charge/discharge path 402. The series of cells comprises a battery that has a positive terminal 409 and a negative terminal 411 at the upper and lower ends of the primary charge/discharge path 402. The balancing circuit 18 is arranged in electrical parallel with the battery 14.

The output voltage signal Vo of each SMD 400, 414 and 416 is connected to a respective junction 408, 431 and 433 between a pair of adjacent cells with series current sensors. Current sensors 417, 418, 442, 444, 446 are positioned on each balancing leg 452, 412, 454, 456, 458. The high rail V+ of each SMD 400, 414 and 416 is connected to the positive terminal of the upper cell of the respective pair of cells, and the low rail V− of each SMD 400, 414 and 416 is connected to the negative terminal of the lower cell of the respective pair of cells.

For example, Vo of a first SMD 416 is connected to the junction 433 between the two lowest cells in the series 423 and 425. The low rail V− of SMD 416 is connected to the negative terminal 411 of cell 425 and the high rail V+ of SMD 416 is connected to the positive terminal of cell 423 (which is at cell junction 431).

In another example, Vo of a second SMD 414 is connected to the junction 431 between cell 421 and cell 423. The low rail V− of SMD 414 is connected to the negative terminal of cell 423 (at cell junction 433). The high rail of SMD 414 is connected to the positive terminal of cell 421 (which is at cell junction 408).

As a final example, Vo of a third SMD 400 is connected to the junction 408 between cell 419 and cell 421. The low rail V− of SMD 400 is connected to the negative terminal of cell 421 (at cell junction 431). The high rail of SMD 400 is connected to the positive terminal 409 of cell 419.

The conductive path from the high rail of SMD 400 to the battery's positive terminal 409 also functions as a balancing leg 452 with respective current sensor 417. And the conductive path from the low rail of SMD 416 to the battery's negative terminal 411 also functions as a balancing leg 458 with respective current sensor 446.

Note that the balancing legs 412, 454, 456 can function as nodes for the output voltage Vo of the SMDs as well as paths for balancing current.

Voltage sensors 410 are connected in parallel to respective cells. Each voltage sensor 410 may generate a signal representative of cell voltage of the respective cell, for example, cell 419.

The voltage sensors 410 are communicatively coupled to the controller 420 as described further below, so that the controller 420 receives voltage information from the respective voltage sensor 410. The communication channels between the voltage sensors 410 and the controller 420 are not shown in FIG. 4.

The output voltage Vo of each SMD 400, 414, 416 is connected via a respective balancing leg 412, 454, 456 to the respective cell junctions 408, 431 and 433. A respective current sensor 418, 442, 444 is electrically connected in series with the balancing legs 412, 454, 456 to generate a signal representative of current through the respective balancing legs 412, 454, 456. Note that the current sensors 417 in the top-most position and 446 in the bottom-most position are optional. If the current sensors are not used for cell impedance measurement as described below, in some embodiments of the system 18 the current sensors 417 and 446 may not be included.

Each current sensor 417, 418, 442, 444, 446 is communicatively coupled to the controller 420 so that the controller receives balancing current information from the current sensors. The communication channels between the current sensors 417, 418, 442, 444, 446 and the controller 420 are not shown in FIG. 4.

Accordingly, at least one controller 420, for example, a digital microcontroller, is connected to the SMDs 400, 414 and 416 via control lines 401 to modulate the SMDs 400, 414 and 416 to establish the output voltage Vo of each SMD 400, 414 and 416. The output voltages Vo may add to or subtract from the voltage on the primary charge path 402 for the respective cells 419, 421, 423, 425 to generate balancing currents that can balance the cells 419, 421, 423, 425. The current sensors 417, 418, 442, 444, 446 may be used to maintain current on the balancing legs 452, 412, 454, 458 and 458 within certain limits or thresholds as explained further below.

In establishing the output voltage Vo, the duty cycle of the SMD 400 is increased to raise the output voltage and decreased to lower it. Operation of the balancing system 18 is discussed in more detail after the next four subsections that describe details of various hardware designs that may be used (independently or combined) in one or more embodiments of the system 18.

### Rectifier DC Restoration and Capacitor Coupling to Isolate the PWM Signals

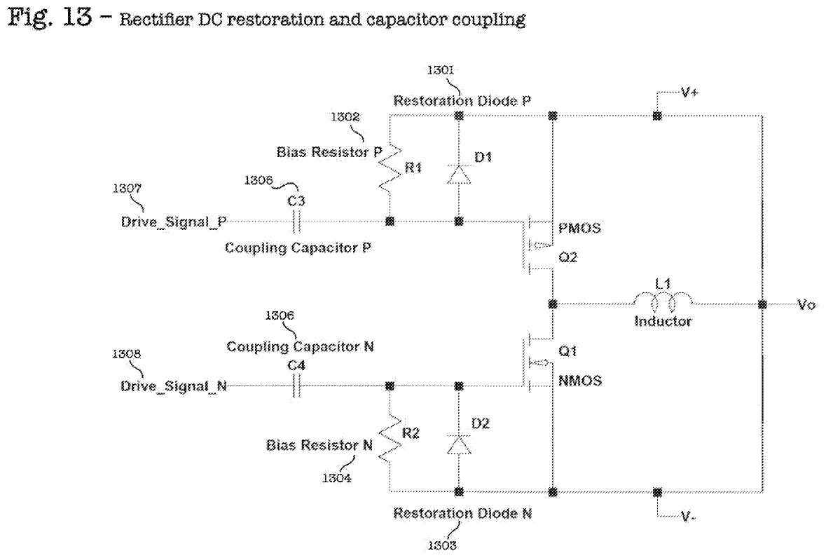

General description of isolation problem: Using the PWM generator in a standard processor (CPU or μP or μC) to drive the FET switches presents electrical isolation challenges. Each SMD in the battery's series stack operates at increasingly higher voltages that are separated from the PWM generator by large DC offset voltages. For example, if an SMD-based balancing system is controlling a battery module with 20 cells in series, the voltage offset between the highest and lowest SMD would be around 80V. This voltage difference, referred to in the art as offset voltage, between the lowest SMD and the highest SMD is a problem and will cause degradation in the performance of the balancing system. FIG. 13 illustrates a means of overcoming the problems associated with offset voltages accruing in the SMDs by using rectifier DC restoration and capacitor coupling.

Rectifier DC restoration is added to the positive and negative sides of the SMD by adding restoration diodes 1301 (on the positive side) and 1303 (on the negative side) in parallel with bias resistors 1302 (on the positive side) and 1304 (on the negative side).

Coupling capacitor 1305 (on the positive drive signal 1307) and coupling capacitor 1306 (on the negative drive signal 1308) are positioned between the source of the drive signals and the rectifier DC restoration elements. The capacitors isolate the DC offset voltage from the PWM generator.

The capacitor-coupled drive technique with DC restoration disclosed above solves the DC isolation problem while allowing a multi-channel PWM generator to control a plurality of SMDs with additional benefits of a low-cost, simple circuit, that supports high balancing currents and very granular control over the PWM signal (and thus very granular control over the SMD's output voltage). In one or more embodiments of the invention the switches in the SMD may be FETs. Those skilled in the art will recognize that the system described herein may also use other kinds of switches.

The circuit described above and illustrated in FIG. 13 enables a single low-voltage PWM generator to drive a plurality of SMDs at arbitrarily high offset voltages. Applying DC restoration to the circuit enables use of a PWM generator that can be fabricated using low voltage techniques and components. This allows use of a single PWM generator to drive a plurality of SMDs connected to a plurality of cells connected in series. This approach enables a significant reduction in the cost-per-cell of the balancing circuit and reduces component count which can increase reliability and reduce failure rates.

An additional benefit of this design is that it allows a single PWM generator to have logical interaction with a plurality of SMDs, which in turn allows coordination of the states and actions of a plurality of SMDs. A single processor can monitor and control the currents on a plurality of balancing legs. This enables operations that are not possible with prior art.

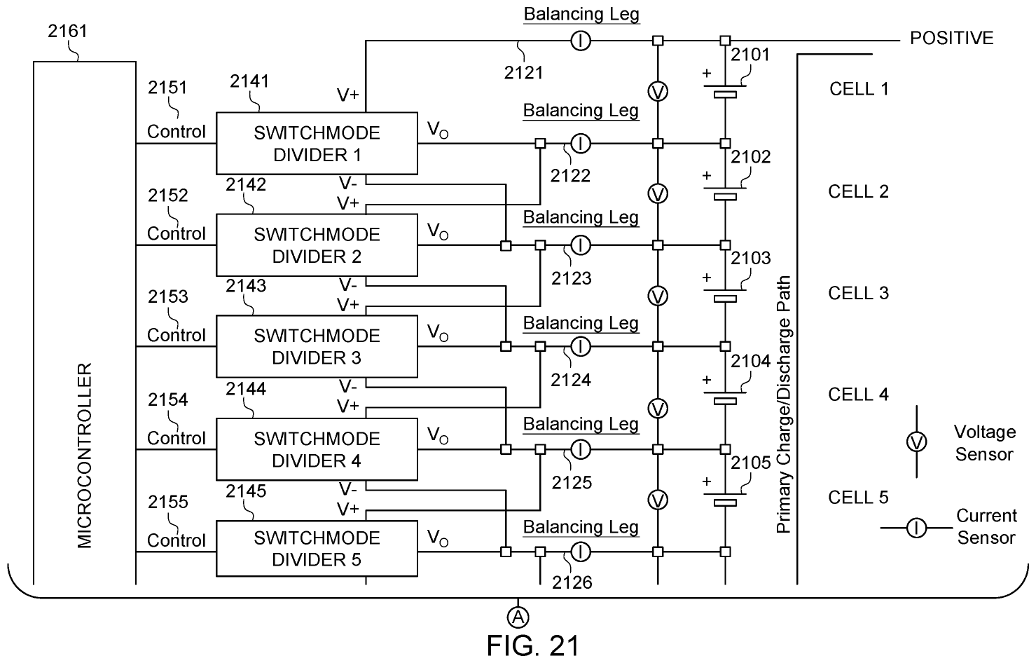

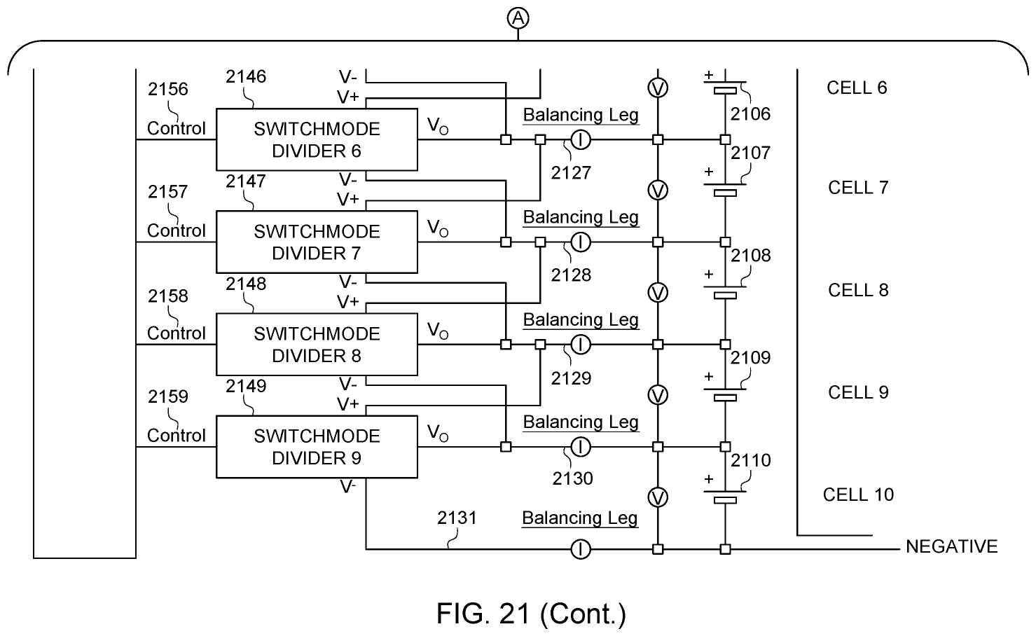

FIG. 21 illustrates a system in accordance with one or more embodiments of the invention. The system in FIG. 21 comprises ten cells 2101 . . . 2110 connected in series; nine SMDs (2141 . . . 2149); and eleven balancing legs (2121 . . . 2131). A controller 2161 includes an embedded PWM generator (not shown) that can generate a plurality of simultaneous independent PWM control signals that can be transmitted on control lines 2151 . . . 2159 to the respective SMDs 2141 . . . 2149. This allows each of the SMD's output voltages (Vo) to be at different values, because each of the PWM control signals can have a different duty cycle.

Two examples of operations enabled by this invention are described herein.

Example 1: The battery may be charging and may be in a state in which several cells (for example, cells three through nine 2103 . . . 2109) are at a lower SOC than other cells (for example, cells one, two and ten 2101, 2102 and 2110) which may be at a relatively higher SOC. In this case, the controller 2161 can modulate SMDs 2141 . . . 2149 to provide charging balancing current to the cells at lower SOC, and to provide zero balancing current or negative balancing current to the cells at higher SOC. The controller 2161 can be aware of the conditions of each cell in the battery and can manage the embedded PWM generator to generate PWM control signals that create patterns of balancing currents allow the balancing process to be completed more quickly and efficiently than prior systems that lack this ability.

Example 2: When measuring impedances of cells in the battery it may be necessary to enable some SMDs and disable other SMDs in a pattern that facilitates impedance measurement (as further described later in this document). Prior art systems are unable to do this; the present invention is able to do this.

These examples are intended to illustrate the utility of the present invention and are non-limiting. Electrically isolating the PWM generator (as described above) enables a single PWM generator to manage a plurality of SMDs simultaneously, which in turn enables control and management of balancing current on a plurality of balancing legs simultaneously. Those skilled in the art will appreciate that there are more examples of utilizing this invention for improved battery performance or improved performance of a balancing system.

### Use of Hall Effect Current Sensors

In one or more embodiments, the current sensors 417, 418, 442, 444, 446 are Hall effect current sensors. Use of Hall effect current sensors enables a simple, low-cost circuit; provides accurate current measurements; allows measurement of high balancing currents, for example 10A or more; and eliminates the need for DC isolation of the current sensors 417, 418, 442, 444, 446, which in turn enables use of the present balancing system in battery packs with many cells connected in series, for example, as many as several hundred cells in series.

### Bias Lines for Connecting the Battery

The balancing system 18 needs to be connected to the battery 14, and the battery 14 is an energy source that cannot be switched off while the connections are being made, for example at the time the battery pack is assembled. As connections are being made, uncontrolled in-rush currents from the battery can damage the balancing electronics.

In general terms, a solution to this problem is to create a bias voltage that is applied to the balancing legs prior to connecting the balancing legs to the battery. Creating a bias voltage that is applied to the balancing system will reduce the level of differential voltages that the balancing system is exposed to when it is connected to the battery, which can reduce in-rush currents to a level that will not damage the balancing electronics.

In one or more embodiments of the invention, the battery can be the source of the bias voltage. This can be achieved by including biasing lines as part the balancing system. A key feature of each biasing line is a resistive element (such as a resistor) that creates a total resistance on the biasing line. The resistance on the biasing lines must be sufficiently large to limit in-rush current when the balancing circuit is connected to the battery, and sufficiently small to provide the circuit leakage currents with voltage drop, typically less than 100 mV. The specific value of the bias resistance will depend on the amount of leakage current of the balancing electronics. Typical values of the bias resistors may be somewhere in the range of 1 kQ to 10 kQ.

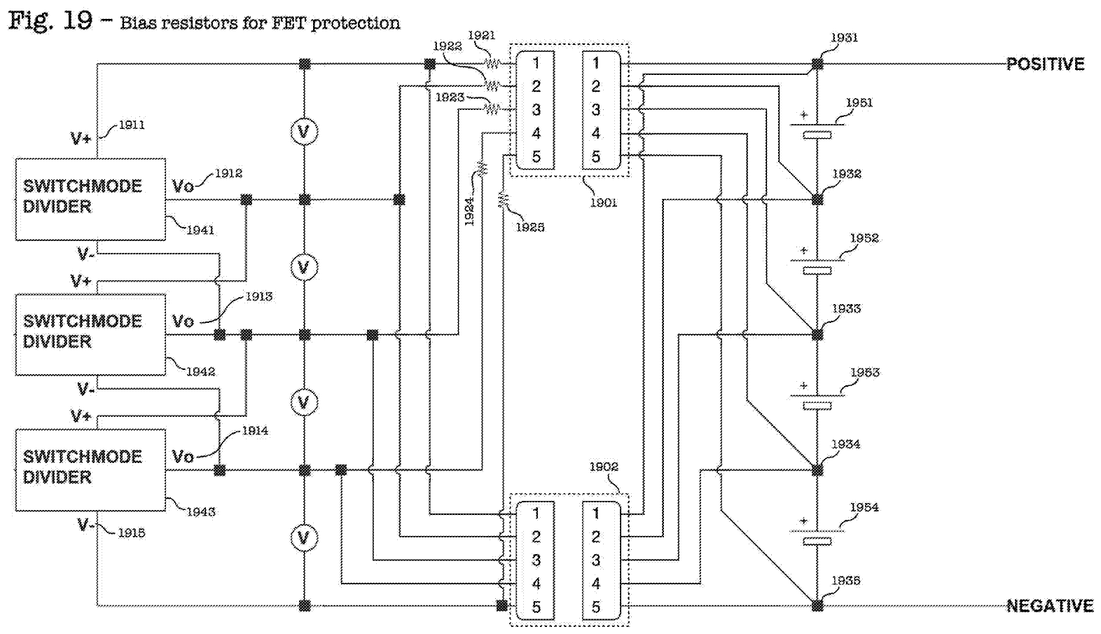

FIG. 19 illustrates an embodiment of a balancing system that includes bias lines with resistors. In this example implementation of the invention, there is a first connector 1901 that establishes a connection of the bias lines between the balancing system and the battery. There is a second connector (1902) that establishes a connection of the balancing legs between the balancing system and the battery.

For example, in a battery that utilizes four cells in series (1951, 1952, 1953 and 1954) and a respective balancing system with three SMDs (1941, 1942, 1943), there may be five bias lines as follows:

A first bias line runs from the high voltage rail 1911 of the uppermost SMD 1941, through a bias resistor 1921, through pin 1 of connector 1901, and terminates at the positive terminal 1931 of the uppermost cell 1951. A second bias line runs from the output voltage (Vo) line 1912 of the uppermost SMD 1941, through a bias resistor 1922, through pin 2 of connector 1901, and terminates at junction 1932 between the uppermost cell 1951 and the next lower cell 1952. A third bias line runs from the output voltage (Vo) line 1913 of the middle SMD 1942, through a bias resistor 1923, through pin 3 of connector 1901, and terminates at junction 1933 between cell 1952 and the next lower cell 1953. A fourth bias line runs from the output voltage (Vo) line 1914 of the lowest SMD 1943, through a bias resistor 1924, through pin 4 of connector 1901, and terminates at junction 1934 between cell 1953 and the lowest cell 1954. A fifth and final bias line runs from the low voltage rail 1915 of the lowest SMD 1943, through a bias resistor 1925, through pin 5 of connector 1901, and terminates at the negative terminal 1935 of the lowest cell 1954.

A second connector 1902 for the balancing legs may establish connections between the balancing system and the battery. It should be noted that the balancing legs run in parallel with the bias lines, as follows:

A first balancing leg starts at the positive rail 1911 of the uppermost SMD 1941. It passes through pin 1 of the second connector 1902 and terminates at the positive terminal 1931 of the uppermost cell 1951. A second balancing leg starts at the output voltage (Vo) line 1912 of the uppermost SMD 1941. It passes through pin 2 of the second connector 1902 and terminates at junction 1932 between the uppermost cell 1951 and the next lower cell 1952. A third balancing leg starts at the output voltage (Vo) line 1913 of the middle SMD 1942. It passes through pin 3 of the second connector 1902 and terminates at junction 1933 between cell 1952 and the next lower cell 1953. A fourth balancing leg starts at the output voltage (Vo) line 1914 of the lowest SMD 1943. It passes through pin 4 of the second connector 1902 and terminates at junction 1934 between cell 1953 and the lowest cell 1954. A fifth and final balancing leg starts at the low voltage rail 1915 of the lowest SMD 1943. It passes through pin 5 of connector 1902, and terminates at the negative terminal 1935 of the lowest cell 1954.

A balancing system that includes bias lines to protect the balancing system from inrush currents at the time the system is connected to the battery may go through the following set of events to safely establish connection to the battery:

The two halves of a first connector 1901 are mated together. This high impedance connection establishes a current limited bias voltage on the balancing system. The bias voltage will then limit in-rush currents when the low-impedance balancing legs are connected to the battery. After bias voltage is established, the balancing legs (1911, 1912, 1913, 1914 and 1915) may be connected to the battery. In an embodiment, the balancing legs (1911, 1912, 1913, 1914 and 1915) may be connected by mating together the two halves of a second connector 1902.

A connector may add impedance to the balancing legs (1911, 1912, 1913, 1914 and 1915), and it may be desirable to have balancing leg impedance as low as possible. Therefore, other embodiments may omit a second connector (1902) and the balancing legs may be connected to the battery by welding wires to connection points on the balancing system and to respective connection points on the battery.

Other low impedance means of connection may be used, such as but not limited to a lug connector that may provide low impedance by high pressure contact.

After electrical connections are established on all balancing legs between the balancing system and the battery, it is no longer necessary to have a bias voltage applied to the balancing system. Therefore, after the balancing legs (1911, 1912, 1913, 1914 and 1915) are connected, the first connector 1901 that established bias voltages may be disconnected. Alternatively, the first connector 1901 may remain connected. If the first connector (1901) remains connected, the parallel paths of the bias lines and balancing legs will not affect the performance of the balancing system.

The use of single-point connections of the bias lines and balancing legs at the cell junctions provides means for accurately sensing cell voltages. Single point connection sensing techniques are well known in the art.

Using a connector 1901 to establish a connection between the bias lines and the battery is a non-limiting embodiment. Those skilled in the art may use alternate means to connect the bias lines to the battery, such as connecting each bias line individually, or using a plurality of connectors rather than a single connector.

If this method of connecting the balancing system to the battery is used, transient inrush currents will be suppressed when the balancing legs (1911, 1912, 1913, 1914 and 1915) are connected to the battery thereby protecting the electronic components of the balancing system from damage.

### Theory and Logic of Operation

Returning to a description of the balancing system 18 of FIG. 4:

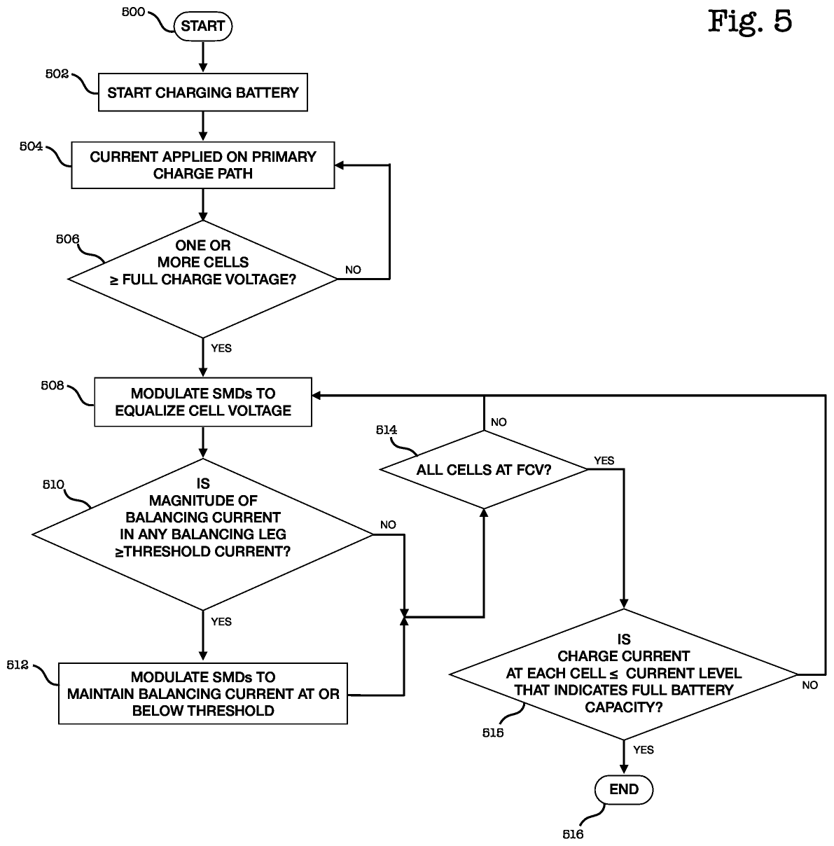

FIG. 5 illustrates the operation of the balancing system 18 during a charging cycle. The process begins at start state 500. Battery charge is commenced at block 502 on a battery 14 (see FIG. 1) with each cell 16 at any SOC, typically below Full Charge Voltage, and with the cells 16 in any condition of balance or out-of-balance. Block 504 indicates that charging is commenced by applying charge current, flowing from the positive to negative terminals on the primary charge/discharge path 402. The magnitude of the current on the primary charge/discharge path 402 may typically be greater than the magnitude of the maximum balancing current on the balancing legs (452, 412, 454, 456, 458) as determined by a threshold.

The voltage of each cell 16 is monitored using the respective voltage sensors 410. When it is determined at decision point 506 that at least one cell 16 reaches or exceeds Full Charge Voltage (FCV), the logic proceeds to block 508 to modulate the SMDs (400, 414, 416) to equalize the cell voltages. That is, in example implementations, cell voltage equalization with current-limiting operation as discussed below starts only when a first cell 16 reaches FCV. In other embodiments, the balancing circuit 18 may start operating before any cell 16 reaches FCV, in which instance input from the current sensors would be used by the controller to limit current through the balancing legs to be no more than a threshold current magnitude before at least one cell reaches full charge voltage during battery charge.

As an example, and referring to FIG. 4, should cell 419 reach a voltage above full charge voltage as indicated by the respective voltage sensor 410 of the cell 419, the microcontroller 420 lowers the voltage of cell 419 by modulating the SMD 400 that is associated with the over-voltage cell 419 to reduce the cell's voltage at a controlled rate until the voltage is at or just below FCV.

As the SMDs (400, 414, 416) are being used to alter the cell voltages, the logic at decision point 510 determines whether the magnitude of the balancing current (positive or negative) as measured by any current sensor (417, 418, 442, 444, 446) is at or beyond a threshold value, typically a maximum allowed current magnitude. This applies to limiting both negative and positive current, because balancing current can flow in either direction.

Note that one threshold may be used for negative current and another, different threshold may be used for positive current, or a single threshold may apply to both. Should the magnitude of any balancing leg current satisfy the threshold, e.g., by being at or beyond the threshold at decision point 510, for instance as a result of having applied modulation of block 508 at an excessive rate of change, the logic moves to block 512 to modulate the SMDs (400, 414, 416) to adjust the voltages of adjacent cells 16 to bring the balancing leg current magnitude at or below the threshold.

In other words, if at any time during the balancing process, the output voltages Vo are adjusted in a manner that results in the magnitude of the current in any balancing leg 412 to be at or beyond the limit threshold, then the modulation of an SMD (400, 414, 416) that is at and/or adjacent to the balancing leg 412 with excessive current is adjusted to reduce the voltage differential between the cell 16 that has excessive balancing current and one or both of the cells that are adjacent to cell 16.

In one or more embodiments of the invention, the controller 420 preferably establishes as much of the allowed magnitude of balancing current as possible, albeit always below the maximum permitted threshold, to provide for the fastest completion of balancing without violating the threshold for balancing leg current magnitude. Thus, in example embodiments the balancing current magnitude is maintained at a high level at or below a threshold to prevent overcurrent conditions that could damage the system or pose a safety hazard.

In modulating the SMDs (400, 414, 416), if the controller 420 determines, based on the signal from a balancing leg current sensor 418, that the current flowing in the balancing leg 412 is too high (e.g., above the threshold) in the positive direction then the duty cycle of the control signal is reduced to lower its output voltage Vo. On the other hand, if the current in the balancing leg 412 is too great in the negative direction, then the controller 420 increases the duty cycle of the control signal and thus raises the output voltage Vo.

Monitoring of voltage and current data and modulation of the SMDs (400, 414, 416) continues until at least one and more preferably two conditions are met. As indicated at decision point 514 it is determined whether all cells 16 have reached FCV. If not, the process loops back to block 508. If all cells have reached FCV, the logic can move from decision point 514 to decision point 515, which applies the logic for a constant voltage (CV) charge profile. Decision point 515 determines whether the balancing current to each cell has decreased to a level indicative of the battery 14 having reached True Battery Capacity. If so, the process ends at state 516. Otherwise, the logic loops back to block 508.

Note that the controller 420 samples cell voltages as indicated by the voltage sensors 410 for ongoing modulation of the SMDs (400, 414, 416) to equalize cell voltages while maintaining balancing current magnitudes at or below the threshold for balancing currents. When output voltage Vo at any one cell 16 is altered, it will affect adjacent cells 16 and adjacent balancing leg currents because the cells 16 are connected in series, so modulation and adjustment of the output voltages of the SMDs (400, 414, 416) is typically an ongoing process while the balancing system 18 is operating.

In one or more embodiments of the invention, the threshold magnitude for the balancing leg current may be established as a function of battery capacity, chemistry of the battery, design of the battery, and use environment. In general, the threshold magnitude of the balancing leg current is selected to be a suitable percentage of the maximum permissible charging current based on the design objectives of the battery system. A higher balancing current threshold allows the battery 14 to reach a balanced state in a shorter time, but a too-high threshold can lead to cell or system damage, so the threshold is established to ensure current in the balancing legs (452, 412, 454, 456, 458) remains below stress levels of the cells or the system.

As an example, in some batteries a balancing current range threshold of 5% to 10% of the maximum primary charge current may be sufficient to ensure 100% balancing within an hour or two under conditions of the battery 14 and cells 16 that would typically occur. The closer the SOCs of the cells 16 are to each other, the lower the balancing range required to achieve complete balance over any given time period. Some designers may opt for a lower range of 2% to 3% of maximum primary charge current, for example, to save cost; while others may opt for a higher range (20% or 30% of maximum primary charge current, for example) if faster balancing times are more important than system cost.

It may now be appreciated that currents on the balancing legs (452, 412, 454, 456, 458) can be advantageously used as proxies for the charge current to each cell 16 in the primary charge path 402. As understood herein, current in the balancing legs (452, 412, 454, 456, 458) correlates closely enough to the main charging current on the primary charge path 402 that it can be used to determine when each cell 16 has reached 100% SOC. This allows the current sensors (417, 418, 442, 444, 446) to be placed on the balancing legs (452, 412, 454, 456, 458) and allows use of current sensors (417, 418, 442, 444, 446) with much lower current rating than would be needed to sense current on the primary charge path 402.

The balancing circuit 18 can reliably, efficiently, and accurately bring every cell 16 in the battery 14 up to 100% SOC at the end of every complete charge cycle. Moreover, the use of current sensors (417, 418, 442, 444, 446) to monitor balancing current enables stability of the balancing system 18. Additionally, by monitoring cell voltage and balancing leg current, the controller 420 can detect when cells 16 reach Full Charge Voltage and then subsequently reach 100% SOC. When a cell 16 first reaches Full Charge Voltage, it is usually not yet at 100% SOC, so additional charging is typically required after Full Charge Voltage to bring the cell 16 up to 100% SOC. This is made possible by the balancing leg current sensor (417, 418, 442, 444, 446) input, which enables accurate, reliable determination of when a cell 16 has reached 100% SOC. An indication of 100% SOC occurs when a cell 16 is at Full Charge Voltage as indicated by the respective voltage sensor 410, and when current to the cell 16 as indicated by the current sensor 418 associated with the cell 16 has dropped to a very low level, typically around 0.05 C to as low as 0.01 C, wherein “C” is a measure of current rate relative to a capacity of the cell. This allows each cell 16 in the battery 14 to be brought up to true 100% SOC and allows the charging and balancing cycle to be terminated before any cell 16 reaches a state of overcharge.

Furthermore, locating the current sensors (417, 418, 442, 444, 446) on the balancing legs (452, 412, 454, 456, 458) avoids compromising the battery's primary charge path 402.

In addition to enabling management of differences in voltage among the various cells 16, using the balancing current as an input to the feedback loop used by the controller 420 mitigates the instability disadvantage of the low impedance SMD (400, 414, 416) configuration while maintaining all the added advantages of that configuration. With use of the current sensors (417, 418, 442, 444, 446), cell voltages need only be approximately measured, while limiting the current in the balancing legs (452, 412, 454, 456, 458) to a finite maximum level effectively eliminates potential loss of control of a high-gain balancing system.

In one or more embodiments of the invention, current and voltage sensors of relatively low accuracy (typical accuracy of 2% of maximum cell voltage for the voltage sensors 410 and 0.03 C for the current sensors (417, 418, 442, 444, 446)) are sufficient because the accuracy (or resolution) of voltage and current measurement only needs to be great enough to detect possible runaway current conditions and make corrections to prevent them, and to ensure that cells 16 do not rise above Full Charge Voltage and/or do not approach Maximum Cell Voltage (the maximum voltage a cell can be charged to without incurring risk of damage to the cell.)

Also, current sensors (417, 418, 442, 444, 446) on the balancing legs (452, 412, 454, 456, 458) can be rated to be relatively small and inexpensive as compared to current sensors that might be placed in the primary charge path 402; the current sensors (417, 418, 442, 444, 446) on the balancing legs (452, 412, 454, 456, 458) do not siphon off energy from primary charge path 402, which would reduce the efficiency of the system. And unlike larger current sensors on the primary charge path, balancing leg current sensors do not generate undue heat.

Because high charge current can be efficiently and safely applied throughout the charge cycle, with charge current dropping to a low level as any cell 16 reaches 100% SOC, faster charge cycles than currently are provided are realized by the balancing circuit 18. Furthermore, the balancing system 18 can balance cells 16 that are significantly out of balance. As long as no cell 16 is defective (essentially, as long as all cells can be charged), the balancing system 18 can bring every cell 16 in the battery 14 up to 100% SOC and into balance with all of the other cells 16 in the battery 14, regardless of the SOC of each cell 16 at the start of the charge cycle.

Variations in cell characteristics do not affect the balancing performance of the balancing system 18. In other words, the balancing system 18 can fully charge and balance a battery regardless of variations in cell characteristics.

The SMDs (400, 414, 416) are modulated by the controller 420 to independently regulate the balancing current to each cell 16 until each cell 16 reaches Full Charge Voltage and high impedance, at which point each cell 16 has reached 100% SOC. In non-limiting embodiments, this can be accomplished while minimizing stress on the cells by modulating the SMDs 200 to establish cell voltages that will bring low voltage cells 16 up rather than bringing high voltage cells 16 down, thereby minimizing current shunting between cells 16. In general, but without limitation, cells 16 can be brought from a discharged state up to a fully charged state in a steady upward charge cycle, with very little or no discharges from individual cells 16 as part of the balancing scheme during charging.

In addition to the advantages noted above, the balancing system 18 eliminates the need to discharge cells 16 through load resistors to maintain balance and overcomes limitations on balancing range that are inherent in some systems. The balancing system 18 enables use of current sensors (417, 418, 442, 444, 446) rated for only a small fraction of the ampacity of the battery, which reduces cost of the current sensing system. The full main charge current can be applied for most of the charging cycle with the balancing circuit 18 preferably switching on only when at least one cell 16 reaches Full Charge Voltage. At this point the other cells 16 have also been charged for some time and will typically be close to Full Charge Voltage. Accordingly, in example embodiments of the invention the cell balancing is performed by the balancing system 18 only near the end of each charge cycle when most or all of the cells are near Full Charge Voltage and only a small amount of balancing current is needed to quickly balance the cells 16 and bring all of them to 100% SOC.

While the above-described balancing process contemplates cell equalization during battery charge, the same principles also may be used during battery discharge. In one or more embodiments of the invention, the logic in controller 420 balances the cells 16 in the battery 14 during a discharge cycle (typically when the battery 14 is powering a load). The logic that equalizes cell voltages while limiting the current on the balancing legs 412 thus may be employed during discharge cycles, during charge cycles as well as during times when the battery is neither charging nor discharging (idle).

As understood herein, balancing during discharge cycles and/or while the battery is idle can increase the available capacity of the battery 14. In a passive balancing system, the battery management system that is typically provided for a battery will electrically disconnect the battery from the load when any cell in the battery 14 has reached a minimum cell voltage. Typically, the weakest cell in the battery will reach minimum voltage first. On the other hand, if a battery is balanced during discharge, stored energy in higher voltage (or higher SOC) cells will be transferred to cells with lower voltage (or lower SOC), thereby increasing available battery capacity.

Current Limiting via Impedance Characterization (CLIC)—a means of limiting balancing current without use of current sensors.

Next a method for approximation or estimation of balancing leg current will be described in example embodiments where a balancing system as described herein does not include hardware current sensors on balancing legs (452,412,454,456) as described above. Thus, it is to be understood that in lieu of a hardware current sensor that senses current through a balancing leg, estimations of current along balancing legs may also be used. Without limitation, estimating balancing current as described below may be referred to as Current Limiting via Impedance Characterization (CLIC).

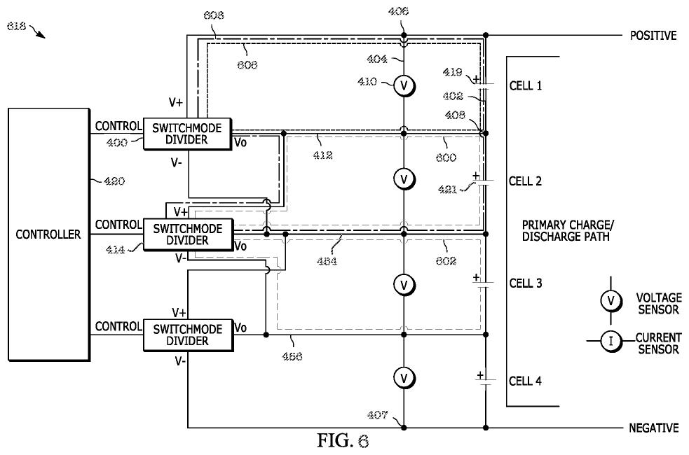

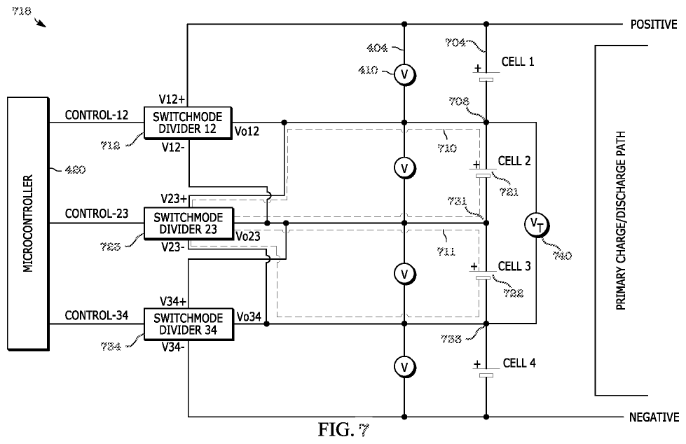

FIG. 6 illustrates a balancing circuit 618 with the current sensors (417, 418, 442, 444, 446) excluded from the balancing circuit 618 of FIG. 4.

FIG. 6 includes illustrations of three conductive loops in the balancing circuit 618. These loops are designated 600, 602 and 606. Each of these loops consists of (a) one SMD 400; and (b) one cell 16 that is connected to the balancing leg 412 associated with the SMD 200; and (c) the conductive paths that complete the loop between the SMD 200 and the respective cell 16. These loops are called SMD-Cell Loops.

SMD-Cell Loops may include relatively low-impedance circuit paths that include two or more voltage sources connected in parallel. For example, the parallel voltage sources in SMD-Cell Loop 606 are the cell 419 and the output voltage Vo from SMD 400.

If the parallel voltages are exactly equal, then zero current will flow in the respective SMD-Cell Loop. Thus, Ohm's Law I=E/R (with “E” being voltage in this case) where E=0 will result in a current I=0 for all non-zero values of R (resistance). When the balancing system is operating, the output voltage Vo for the respective SMD 400 may be adjusted in accordance with the algorithm of FIG. 5 to cause a corresponding balancing current to flow in the balancing leg 412 circuit path. The current flowing in the respective balancing leg 412 and thus the resultant balancing current that is applied to the respective cells may be limited to a threshold level at or below the design limit of the system as described above in FIG. 5 as the threshold current, thereby preventing excessive current that can stress and/or damage the system.

Note that two SMD-Cell Loops are associated with each SMD. For example, SMD-Cell Loops 600 and 606 share a common balancing leg 412 that connects the output voltage Vo of SMD 400 to the cells that comprise the cell junction 408 that the balancing leg 412 connects to. SMD-Cell Loop 606 contains the cell 419 that is on the positive side of junction 408 and SMD-Cell Loop 600 contains the cell 421 that is on the negative side of junction 408. The currents on the two SMD-Cell Loops 600 and 606 add together to form the total balancing current on balancing leg 412.

A CLIC system as illustrated in FIG. 6 (where there are no hardware current sensors) may be used whereby the controller 420 calculates an approximation of the current on the respective balancing leg 412. It may do so by characterizing the impedance of the respective SMD-Cell Loops (characterization of impedance typically may be done at the time of design or assembly of the system 618 as further described below), estimating the voltage Vo on the respective balancing leg 412 as controlled by the respective SMD 400, and receiving data from the respective voltage sensors 410 of the respective SMD-Cell Loops 600 and 606 that are adjacent to the respective cells 419 and 421 connected to the balancing leg 412. With these three parameters, the controller 420 may estimate (using Ohm's Law) the current flowing in the respective balancing leg 412 without the use of a hardware current sensor 418 which could perform a direct measurement of the balancing leg current.

In non-limiting examples, the current flowing in any given balancing leg may be the algebraic sum of the currents flowing in all of the various loops in the system 618 which include the respective balancing leg or legs, one or more corresponding SMD outputs Vo, and one or more corresponding battery cells. Loop 608 is an example of a current loop in system 618 that contributes to the total current flowing on balancing leg 412, but which is not an SMD-Cell Loop per se, because loop 608 comprises two SMDs (400 and 414) and two cells (419 and 421). Loop 608 has a second-order effect on the balancing current on balancing leg 412 relative to the contributions of SMD-Cell Loops 600 and 602. If there are additional cells in series in the battery, the further the cells are from the SMD-Cell Loop that is being characterized, the smaller the impact these cells may have on the current on the balancing leg in question. Nonetheless, it may be desirable to compensate for the impact that these other cells in the battery have on the balancing current in a balancing leg that is being characterized.

The application of Thevenin's Theorem allows the reduction of the balancing leg current to a simplified function proportional to the Vo voltage on the respective balancing leg 412 and the combined (Thevenin equivalent) loop impedance of the associated current paths and the impedance of the cell(s).

In non-limiting practical applications, each SMD 400 may be connected to multiple cells 16 using conductive paths of copper wire, connectors, and copper printed circuit board (PCB) traces. However, note that other suitable materials besides copper may also be used. Regardless, the Vo voltage of the SMD outputs may still be adjusted by the controller 420 using the algorithm of FIG. 5 but note that the specific value at which any Vo should be set using the algorithm of FIG. 5 can be estimated even without input from a current sensor indicating a respective current in a respective balancing leg because the value of Vo is a direct function of the duty cycle of the corresponding SMD 400 (as modulated by the controller 420) and its associated voltages V+ and V− (which may be measured by the respective voltage sensor(s) 410 in the respective loop). Employing CLIC, the impedance of all elements in the loop (including cell impedance) may be characterized and the value of Vo can be approximated by calculating an estimate of the respective balancing leg current.

The characteristic impedance of the Vo output for each SMD 400 may be a function of the total loop impedance of the respective SMD circuit. Items that contribute to Vo output impedance may include the SMD switches (such as field-effect transistors (FETs) and/or comparable bipolar transistors), the filter inductor impedance of the SMD and the filter capacitor impedance of the SMD, and the various circuit board traces that connect these circuit elements to the Vo output electrode.

As a practical consideration, the impedances of loops such as 600, 602, 606 and 608 may be a known parameter that can be determined when the system is designed, as the impedances of the loops are a function of the circuit connections that include components and conductive paths inside the SMD as well as wires, connectors and any other conductive paths between the Vo output electrode and the battery cells. Alternatively, the impedances of loops such as 600, 602, 606 and 608 can be determined empirically (by measurement), for example at time of manufacture.

Note that the impedances of individual components in the loop and the copper wire and connectors can vary with temperature and therefore if variations in impedance due to temperature fluctuations should be accounted for in a given implementation, temperature fluctuations can be determined by including temperature sensors (not shown) within the system 618. Temperature sensors might be located, for example, at or adjacent to the battery cells 16 and/or somewhere along the printed circuit board (or other components) that comprise the system 618. Temperature coefficients for the various components and elements of the system 618 could be stored locally, for example in system memory 22. A look-up table or database containing these temperature coefficients could be applied to temperature measurements taken with the temperature sensors to calculate or estimate the loop impedances, corrected for the instant local temperature. The database or look-up table may be populated based on empirical determinations made by the battery manufacturer prior to vending. Alternatively, a temperature/impedance coefficient can be calculated or estimated for the entire system 618 and this aggregate temperature coefficient can be applied to changes in temperature to estimate changes in impedance of the system 618.

To employ CLIC as a method of estimating current on the balancing legs, a basic transfer function from the PWM value of the respective SMD to the resulting balancing leg current can be established. This transfer function may be affected by multiple factors and as described herein may only need to be approximate to ensure that the high and low extents of the PWM duty cycle may be limited such that the range of resultant Vo values based on current estimation produce a balancing leg current at or below a desired threshold current magnitude. This threshold may be referred to as a second threshold current magnitude that may be a predetermined amount less than the first threshold current magnitude described above (which is the maximum permitted threshold used to prevent overcurrent conditions). The second threshold current magnitude, which may be used in the CLIC method, may be set at a magnitude less than the first threshold current magnitude to safeguard against coming close to or exceeding the first threshold current magnitude.

For any given SMD in the system 618 the parallel voltages can be reduced to three values: the output voltage Vo of the corresponding SMD and the voltages as measured by the voltage sensors 410 of the corresponding two cells connected to the respective balancing leg. In accordance with Ohm's Law, the algebraic sum of these voltages when divided by the combined characteristic impedance of the respective loops containing those voltages may provide an approximation of the balancing leg current for the respective balancing leg.

Next, a numeric example of estimating Vo using CLIC is provided in reference to a four-cell battery configuration as shown in FIG. 7. As may be appreciated from FIG. 7, a balancing system 718 may be similar in many respects to the system 18 and include many of the same components arranged similarly as in the system 18, including a controller 420 and primary charge/discharge current path 704 for cells arranged in series. This example shows how to estimate output voltage Vo23 as a function of the duty cycle applied to SMD23 723 so as to maintain the balancing current within a range of 2.5 A, which (in this example) may be the second threshold current magnitude referenced above.

Output voltage Vo23 may be connected to the junction 731 of CELL2 721 and CELL3 722. The high and low rail electrodes (V23+ and V23−) of the SMD23 723 may be connected respectively to the positive terminal of CELL2 721 at junction 708, and to the negative terminal of CELL3 722 at junction 733.

The input signal (CONTROL-23) to SMD23 723 may be a square wave signal. The PWM duty cycle of the square wave signal may be generated by the microcontroller 420.

In one example embodiment, the high time of the square wave control signal connects V23+ to Vo23 and the low time of the square wave control signal connects V23− to Vo23. Note that V_{T} 740 shows where the voltage difference between the top of CELL2 721 at junction 708 and the bottom of CELL3 722 at junction 733 may be measured and is not an indication that there is a voltage sensor designated as “V_{T}” from the top of CELL2 721 to the bottom of CELL3 722. Rather, V_{T} 740 just illustrates where/how V_{T} 740 may be measured in this example by adding together the values from the respective voltage sensors 410 connected in parallel to CELL2 721 and CELL3 722.

The duty cycle of the square wave control signal may be expressed as a scalar value between zero and one, as illustrated in the following three examples. First, a duty cycle of 1.00 may connect V23+ to Vo23 continuously. Second, a duty cycle of 0.00 may connect V23− to Vo23 continuously. Third, a duty cycle of 0.50 may connect V23+ and V23− to Vo23 alternately and for equal time periods. Thus, a duty cycle of 0.50 may produce a symmetrical square wave which results in a value of Vo23 midway between V23+ and V23− for SMD-23 723, which may be expected behavior of an SMD.

Accordingly, when the balancing system 718 is active, the respective SMD 723 may generate a low impedance divided voltage, Vo, which may always be between V+ and V− according to the duty cycle of the square wave control signal. Modulating the duty cycle of the control signal may therefore generate a voltage at Vo that ranges between V+ and V−, depending on the duty cycle of the control signal.

Note that a theoretically ideal circuit would have the following characteristics. First, both switches in the SMD would have zero impedance when on, and infinite impedance when off. Second, the filter inductor in the SMD would have zero resistance. Third, the connections to the cells (wires and printed circuit board traces) would have zero resistance. Fourth, the respective battery cells would have zero impedance and equal voltages. With a theoretically ideal circuit, a control duty cycle of exactly 0.50 would result in a Vo value exactly equal to the voltage at the junction of the two battery cells. In this case, zero current would flow in the balancing leg because the circuit would be exactly balanced. (Note: In this context, “balanced” refers to the condition of the theoretically ideal circuit and not to the relative SOCs of the cells in the battery.) Thus, under these theoretical ideal conditions, any duty cycle other than 0.50 would imbalance the circuit and produce theoretically infinite current.

But in a real-world circuit, the aforementioned elements from the immediately preceding paragraph may have a finite nonzero resistance or impedance. As such, the duty cycle can be varied to produce an at least somewhat predictable, finite current on the balancing legs.

Two SMD-Cell Loops are highlighted in FIG. 7. A first SMD-Cell Loop 710 may begin at V23+ of SMD-23 723 and extend to the positive terminal 708 of CELL2 721, across CELL2 721, to the negative terminal 731 of CELL2 721, then on to the balancing leg of SMD-23 723, across to the positive side of SMD-23 723, and back to V23+ of SMD-23 723. As also shown in FIG. 7, a second SMD-Cell Loop 711 may begin at V23− of SMD-23 723, extend to the negative terminal 733 of CELL3 722, across CELL3 722 to the positive terminal 731 of CELL3 722, on to the balancing leg of SMD-23 723, then across SMD-23 723 and back to V23− of SMD-23 723.

Currents flow in the same direction at the balancing leg around SMD-Cell Loops 710 and 711, and so current flowing around SMD-Cell Loops 710 and 711 will always be additive at the common balancing leg to create the total current in the balancing leg of SMD-23 723.

A numerical example will now be provided that uses impedance values that may occur in a real-world circuit to illustrate how to calculate PWM duty cycles that would yield a maximum (absolute value) balancing current flowing in the balancing leg connected to Vo23 for the second threshold current magnitude referenced above when using the CLIC method. In this example, the second threshold current magnitude is ±2.5 A.

According to this example, assume each cell has an impedance of 0.004Ω. The two SMD-Cell Loops 710, 711 may be connected in parallel, and so the parallel combination of cell impedance for this example is 0.002Ω.

The impedance values in the table below may be representative of materials at a temperature of 25° C.:

| | |
|---|---|
| SMD Vo output impedance | 0.083 Ω |
| PCB trace copper | 0.006 Ω |
| Cell wiring | 0.015 Ω |
| Connectors | 0.006 Ω |
| Two cells connected in parallel | 0.002 Ω |
| Total circuit impedance | 0.112 Ω |

Using this example of an effective circuit impedance of 0.112Ω, the condition that will create a maximum balancing current of 2.5 A (two and one half amps) may be a differential voltage between Vo and the cells of 0.280V, which is calculated by multiplying 2.5 A by 0.112Ω. One half of this voltage (0.140V) may appear across each loop 510, 511.

For example, if V_{T} 740 has a value of 7.4V (3.7 volts for each cell), the Vo output voltage that will result in a balancing current of +2.5 A will be 3.840V (by adding 3.7V and 0.140V). This output voltage may correspond to a duty cycle of approximately 0.5189 (by dividing 3.840V by 7.4V).

The Vo output voltage that will result in a balancing current of −2.5 A will be 3.560V (by subtracting 3.7V minus 0.140V). This output voltage may correspond to a duty cycle of approximately 0.4811 (by dividing 3.560V by 7.4V).

Therefore, in this example, setting duty cycle limits to a maximum of 0.5189 on the high side and a minimum of 0.4811 on the low side may effectively limit the balancing current between +2.5 A and −2.5 A

Note that the calculations described in reference to this example may be applicable to a battery consisting of two cells in series. But if the battery has more than two cells in series, there will be additional current loops that are associated with SMDs that may be above or below the respective SMD under consideration. Current flowing through these adjacent loops will affect the current flowing in the balancing leg of the respective balancing loop under consideration.

Thus, in a battery with more than two cells in series, the balancing loop under consideration may need to be isolated from any cell balancing loops that are above or below it in the battery in order to characterize the impedance of the loop under consideration. This may be done by disabling (e.g., opening the switches in) the SMDs (712 and 734) above and below the SMD 723 of the loop under consideration to isolate the loop under consideration. Disabling adjacent SMDs (712 and 734) by opening the switches creates high impedance in the adjacent control loops, which makes the adjacent control loops have negligible effect on the current flowing around the SMD-Cell Loops (710 and 711) under consideration.

For example, and referring to FIG. 7, to evaluate the PWM limits for setting Vo23 at SMD-23 723, the first step may be to disable SMD 12 712 and SMD 34 734. This may effectively disconnect V12− from Vo23 and effectively disconnect V34+ from Vo23. Then the calculations described above can be performed to establish the PWM values which will limit the current flowing in the respective balancing leg connected to Vo23.

The foregoing process of disabling SMDs above and below a subject SMD for setting the duty cycle limits of a subject SMD can be performed on any balancing loop associated with any subject SMD in the battery pack. For the SMD at the highest voltage position in the pack, it may only be necessary to disable the SMD immediately below it. And for the SMD at the lowest voltage position in the pack, it may only be necessary to disable the SMD immediately above it.

Further describing temperature correction as referenced above: The impedances of the SMD components (in an embodiment, two transistors, one inductor, two capacitors, and connections), copper wire and connectors can vary with temperature. So that variations in impedance due to temperature fluctuations may be accounted for, note the following.

In many example embodiments of the invention described herein, the impedance values of the system 718 may primarily be a function of copper conductors and semiconductor switch ON resistance, both of which may have a positive temperature coefficient. Therefore, the impedance values described above may decrease as the temperature decreases. Additionally, the cells may have a negative temperature coefficient which may at least partially offset the positive temperature coefficient of other elements of the circuit. The offsetting negative temperature coefficient of the cells may be relatively minor as battery cell impedance is typically a lower value than the impedance of other components in the loop that are connected to the cell.

Thus, a balancing current limit value derived using the CLIC method above may be temperature dependent. Accuracy may be improved if temperature compensation of the impedance variation is employed. Temperature may be measured at the electronics and at the cells using temperature sensors. Since the impedance values of the balancing electronics may dominate over the impedance values of the battery cells, an overall positive temperature coefficient of the complete circuit (including the cells) may exist. Characterization of circuit impedance using impedance values associated with the lowest manufacturer-rated or manufacturer-specified operating temperature of the parts and components may ensure the balancing current is always less than the first threshold current magnitude since the current will tend to decrease as the temperature increases.

Contrasting the CLIC method as described above versus use of hardware current sensors (e.g., per FIG. 4), note that the total cost of a system using the CLIC method may be less than the cost of a system using hardware current sensors, since current sensors may be omitted from the balancing circuit when using the CLIC method. However, the CLIC method estimates balancing current in lieu of measuring current with current sensors, so in some example instances estimates of current using CLIC may be less accurate than using hardware current sensors. Thus, relative to using hardware current sensors, the CLIC method in at least some instances may have a larger error term associated with the resulting balancing current value and therefore may be compared to the second threshold current magnitude value mentioned above to provide a greater safety buffer to prevent overcurrent conditions. For example, if the CLIC method has an inherent error of ±20% for a given system, and if the maximum balancing current that the system can tolerate is 3 Amperes (the first threshold current magnitude described above), then the second threshold magnitude current may be set at 2.5 Amperes (positive or negative) or even less to assure that the actual balancing current (as opposed to the estimate of balancing current) does not exceed the 3 Ampere threshold.

Thus, the second threshold current magnitude value may be limited so as to stay safely away from and not exceed the design capabilities of the balancing hardware. The calculated (or estimated) magnitude of Vo when using CLIC may therefore be less precise than if current sensors are used, so the second threshold current magnitude value may be set such that the value of Vo yields a balancing current that is consistently restricted from exceeding the first threshold current magnitude value which could compromise the reliability or safety of the balancing system hardware.

Accordingly, the CLIC method of sensing balancing current can provide cost savings by eliminating the hardware current sensors 218 from the system, with possible reduced accuracy in some examples in the estimation of balancing current and with possible reduced accuracy in some examples in the estimation of cell characteristics (which may include cell impedance and cell state of health (SOH)). In general, the greater accuracy of characterizing cell impedance afforded by hardware current sensors may enable more accurate characterization or estimation of cell characteristics such as state of health (SOH) in at least some examples.

Additionally, the second (narrower) balancing current threshold that may be employed when using the CLIC method to sense and limit balancing current may increase the time required to complete the balancing process relative to the time required when using current sensors, which may employ the first (wider) balancing current threshold.

In example embodiments of the invention where hardware current sensors are not used and the CLIC method is employed as a method of limiting balancing current, it may be useful at times to recalibrate the total loop impedance for the respective loop. Recalibration may involve periodic application of reference currents on the primary charge path while the battery is unloaded (e.g., not being used to power a load external to the battery pack) and when the battery is not being charged. The periodic application of reference currents for recalibration may be based on a recurring period of time recommended by the battery's manufacturer, such as every hour, every day, every week, every year, or after a specified number of charge cycles (e.g., every 10 cycles or every 100 cycles).

The reference currents can be switched on at two or more known levels. For example, an initial reference current can be applied at 100% of the first current magnitude threshold and then a subsequent reference current can be applied at 50% of the first current magnitude threshold. Measuring the resulting cell voltages at the two or more reference currents using voltage sensors 410 may therefore be used to estimate effective impedance of the cells at any given time. Taking these measurements thus provides an updated estimate of the effective impedance of the cells for use in the CLIC mathematical model. The parameters of the Vo transfer function can thus be updated to compensate or correct for variations in cell impedance characteristics that occur over time and use of the battery.

For example, in a balancing system where 3 A establishes the first current magnitude threshold, the 100% reference level current (3.000 amperes) might produce a cell voltage of 3.850V depending upon the state of charge (SOC) of the cell. A 50% reference current (1.500 amperes) applied to the same impedance loop might produce a cell voltage of 3.843V. Subtracting 3.850V minus 3.843V yields a difference of 7 mV. In this example, the change in current of 1.5 A (3.0 A minus 1.5 A) may produce a differential voltage of 7 mV. Using Ohm's Law (7 mV/1.5 A), these measurements indicate a cell effective impedance of 4.67 mΩ. Using this reference current method, the effective impedance of the individual cells can be measured and then added to or subtracted from the total loop impedance of the Vo balancing leg and cell circuits.

The present application also recognizes that battery cell impedance may change over time such that cell impedance may increase as cells 16 age. Using hardware current sensors, recalibration in response to changes in cell impedance may not be required since, in using hardware current sensors, any change in cell impedance can be characterized directly using the current sensors 418.

To reiterate, note that calibration of cell impedance may not be needed if the battery has and employs the hardware current sensors described above. Calibration (or recalibration) can optionally be performed when employing the CLIC method for estimating and limiting balancing current.

In systems that employ CLIC, recalibration may in some instances only be desirable to maintain the highest balancing leg current that is possible as cell impedance increases with age while providing a suitable safety buffer between second current magnitude threshold and the first current magnitude threshold. As cell impedance increases with age, current for cell balancing will correspondingly decrease over time, thus maintaining the limited maximum balancing leg current below the first current magnitude threshold in embodiments that employ CLIC without calibration. Thus, while employing CLIC, calibration or recalibration may not be needed to maintain safety, but it can be employed to optimize balancing current as the cells 16 degrade. Without recalibration, CLIC may still be used and may be effective at estimating balancing leg current, but may in some instances keep balancing leg current at less than possible values as time goes on.

### PWM Limiting: Control Balancing Current by Limiting the Range of PWM Duty Cycles

Two means of controlling or limiting balancing current to prevent it from exceeding a threshold have been described above: (1) using current sensors on the balancing legs and (2) characterizing impedance on the balancing loop as described in the section about CLIC. A third means of controlling or limiting balancing current is now disclosed. This third means is called PWM limiting, and it controls balancing current by limiting the range of PWM duty cycles that are applied to SMDs. As described herein, upper and lower limits are established for PWM duty cycles, and control logic or software will not allow PWM duty cycles to exceed these limits.

### Terminology Used in the Description of PWM Limiting

PWM duty cycles are expressed as a percentage. A duty cycle of 50% means the signal is high 50% and low 50% of the time. A duty cycle of 75% means the signal is high 75% and low 25% of the time. The higher the duty cycle percentage, the closer Vo is to the voltage on the positive rail of the SMD (V+). The lower the duty cycle, the closer Vo is to the voltage on the negative rail of the SMD (V−).

PWM+ refers to a PWM duty cycle that creates the greatest positive balancing current which does not exceed a threshold on the positive side.

PWM− refers to a PWM duty cycle that creates the greatest negative balancing current which does not exceed a threshold on the negative side.

PWM_{active} refers to the duty cycle that is active on a given balancing leg at any given time.

PWMₙᵤₗₗ refers to a duty cycle that yields a balancing leg current as close as possible to 0 A. Typically, the duty cycle for PWMₙᵤₗₗ will be close to 50%, but may be higher or lower than 50% depending on the condition of the two cells that the SMD's balancing leg is connected to.

Note: PWM+ will have a duty cycle greater than PWMₙᵤₗₗ and PWM− will have a duty cycle lower than PWMₙᵤₗₗ.

Current Signal Generator (CSG) is a system that can generate a known reference current (positive or negative) on the battery's primary charge/discharge path. A current-controlled power source is required to generate a positive reference current. A characterized load is one way to generate a negative reference current.

A CSG can generate a positive reference current on the primary charge path while the battery is connected to a charger, while the charger is connected but is not charging the battery, or while the charger is charging the battery with a known constant positive current. The CSG can also generate a negative reference current on the primary charge path (i.e., a discharge current) by applying a load to the battery (such as with a load resistor or a programmable negative current source) while the battery is otherwise idle (not being charged and not being discharged into an external load).

Zero-current cell voltage (VZ) is the voltage measured between the positive and negative terminal of a cell when there is no current flowing into or out of the cell. If the battery architecture consists of chains of cells connected in parallel with the parallel chains connected in series, each parallel chain of cells is treated as a single large cell.

Mutually isolated SMDs: In a circuit that contains interconnected SMDs (such as the system 18), if adjacent SMDs are simultaneously active, they will affect the current on each other's respective balancing legs. And if SMDs that are one step removed from each other are simultaneously active, they also will affect each other.

When the system is calculating values for PWM+ and PWM−, any active SMDs must be mutually isolated.

For example, if a battery has 12 cells in series, it may have 11 SMDs that may be designated with numbers 1 to 11. If SMDs 2 and 3 are simultaneously active they will affect the balancing current on each other's balancing legs. And if SMDs 2 and 4 (one step removed from each other) are simultaneously active they will also affect each other. However, SMDs 2 and 5 are far enough removed from each other to be mutually isolated, so they will not affect each other if both are active simultaneously.

Therefore, one way to enable SMDs so they are mutually isolated is to enable every third SMD. For example, if the battery has 12 cells in series, and has 11 SMDs, the SMDs could be enabled in three mutually isolated sets. The first set of SMDs to be enabled could be SMDs 1, 4, 7 and 10. The second set of SMDs to be enabled could be SMDs 2, 5, 8 and 11. The third set of SMDs to be enabled could be SMDs 3, 6 and 9. Enabling every third SMD in this sequential manner assures that the SMDs will not interfere with each other during the scanning process.

Enabling every 3^{rd} SMD is a non-limiting embodiment. There are other ways to enable the SMDs so that they are mutually isolated. In other non-limiting examples, the SMDs could be enabled one at a time; or every 4^{th} SMD could be enabled or every 5^{th} SMD.

### Theory of operation of PWM Limiting

If PWM_{active} never exceeds PWM+ on the positive side and never exceeds PWM− on the negative side, then the balancing current will never exceed the specified threshold for maximum absolute value balancing current. This allows high balancing currents, safe operation of the balancing system (balancing currents don't exceed a safety threshold) and eliminates the current sensors (which reduces cost and power consumption).

As an example, PWM duty cycle could be limited to a range from PWM+=53% on the positive side to PWM−=45% on the negative side. The values of PWM+ and PWM− will vary depending on differences in condition of the cells and on differences in positive and negative impedances in the SMDs.

The values of PWM+ and PWM− can be set as parameters, for example, in software or control logic or system memory. A control algorithm that manages PWM duty cycles can prevent PWM_{active} from ever exceeding the boundaries established by the values of PWM+ and PWM−. This is an effective means to limit balancing current (for example, to prevent it from exceeding a threshold) and removes the requirement for a current sensor to limit balancing current on the balancing legs. This is called “PWM limiting” because the PWM duty cycle is used as a means to limit the maximum balancing current, which can be helpful to prevent overcurrent conditions that could be unsafe.

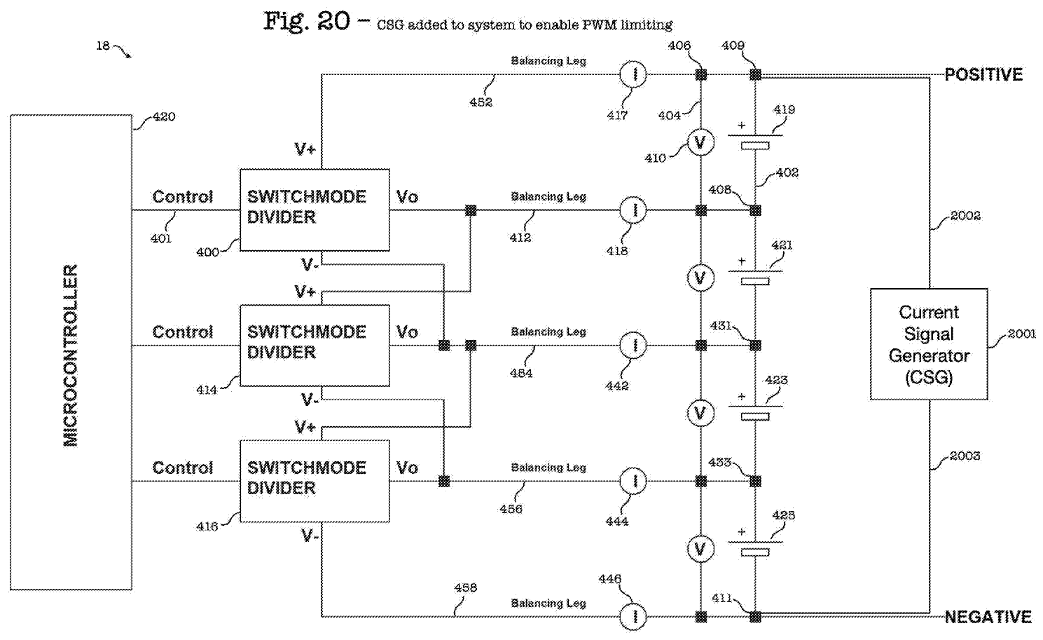

FIG. 20 illustrates a balancing system 18 with the addition of a current signal generator (CSG) 2001 to enable PWM limiting. The CSG 2001 has a positive lead 2002 that connects to the positive terminal 409 of the battery, and a negative lead 2003 that connects to the negative terminal 411 of the battery. In one or more embodiments of the invention the CSG may be external to the battery. For example, it may be an element of a battery charging system. In other embodiments of the invention the CSG may be internal to the battery, albeit typically relying on an external power source to generate a positive reference current.

### How to Determine Values of PWM+ and PWM−

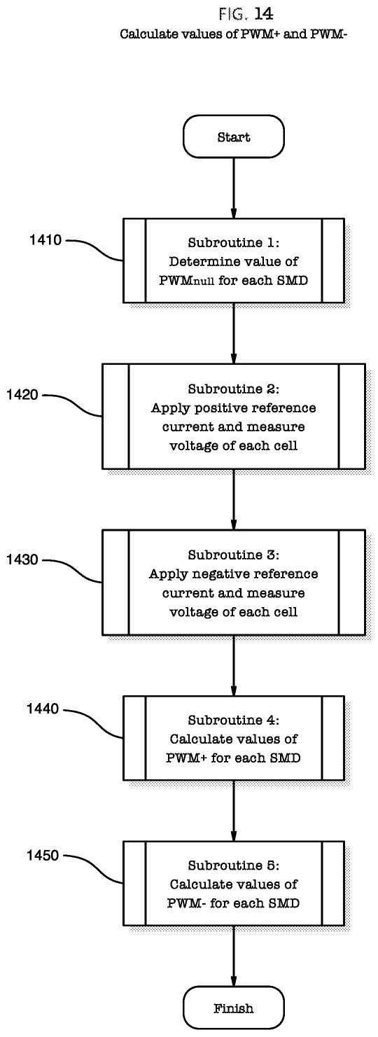

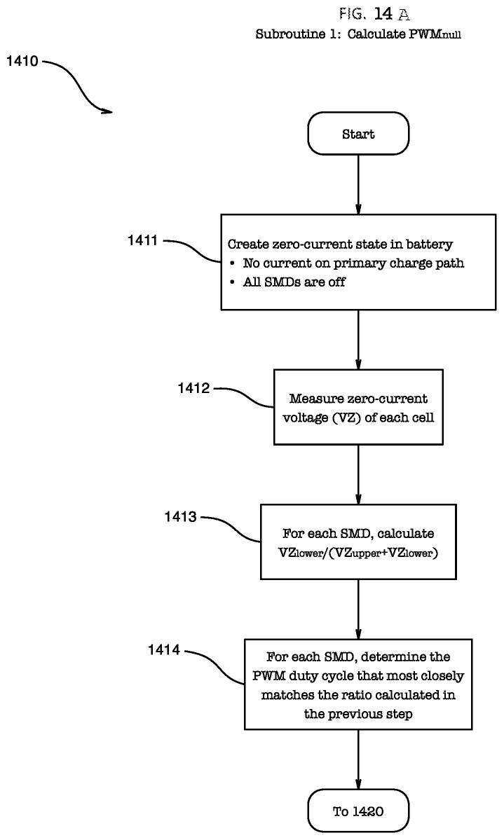

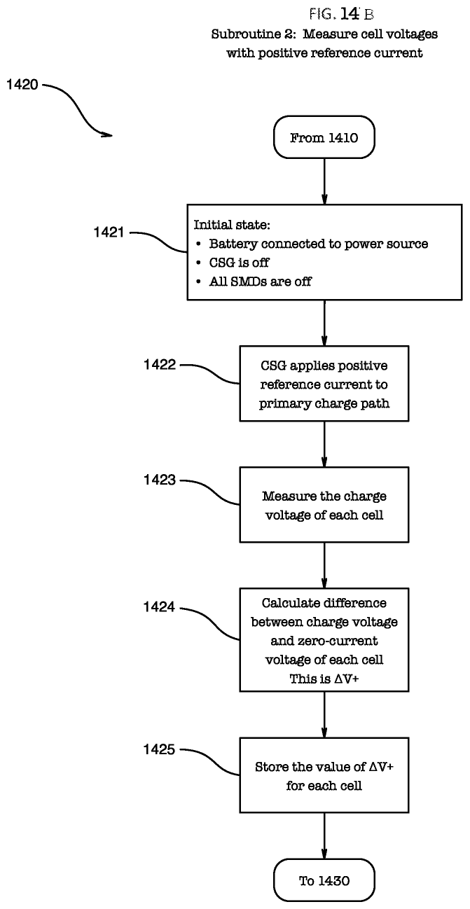

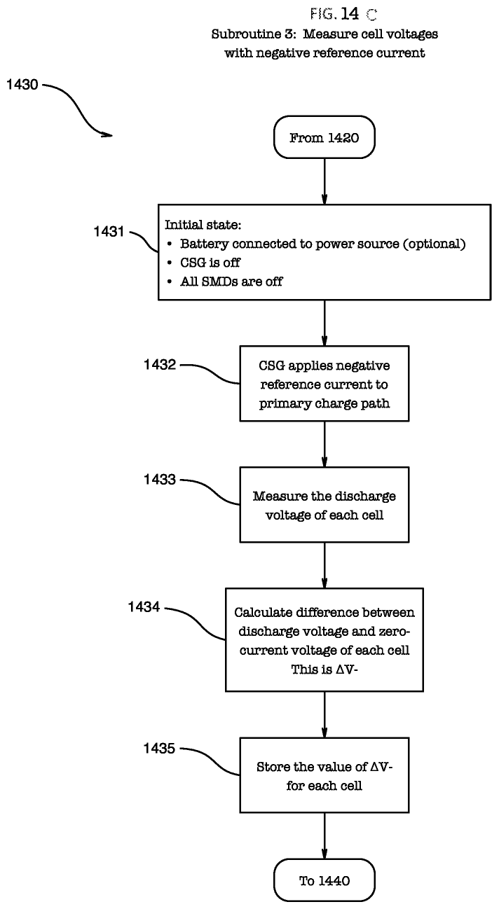

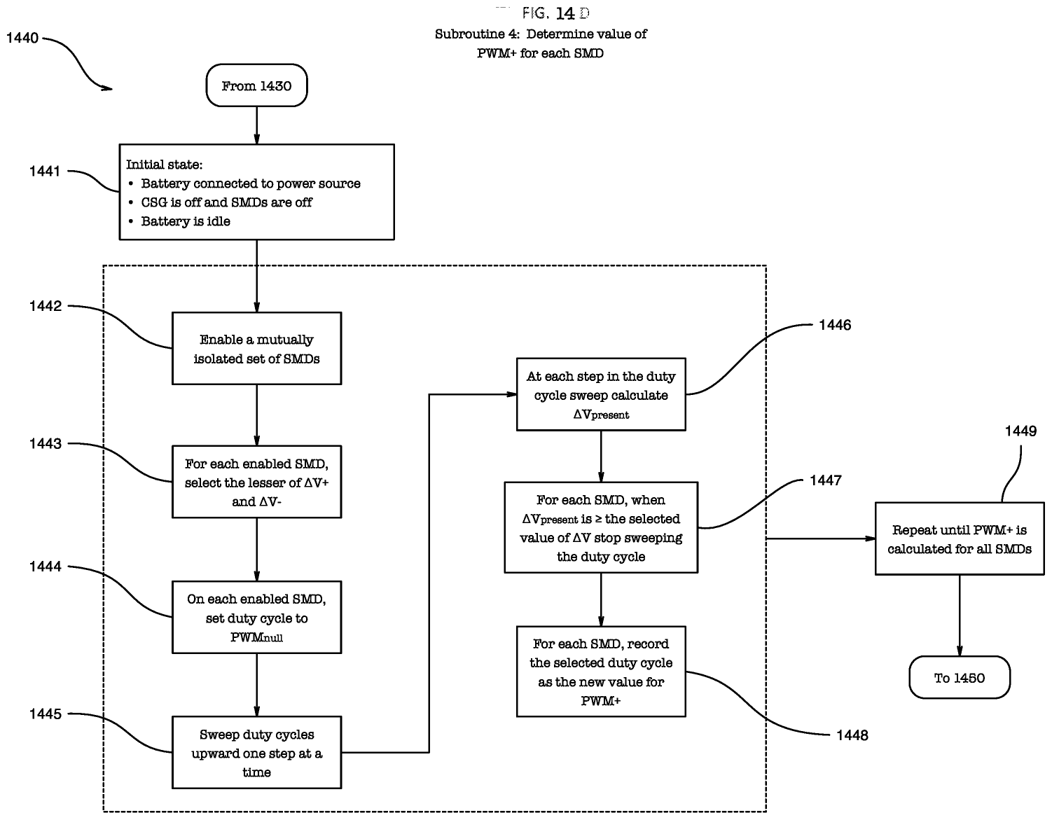

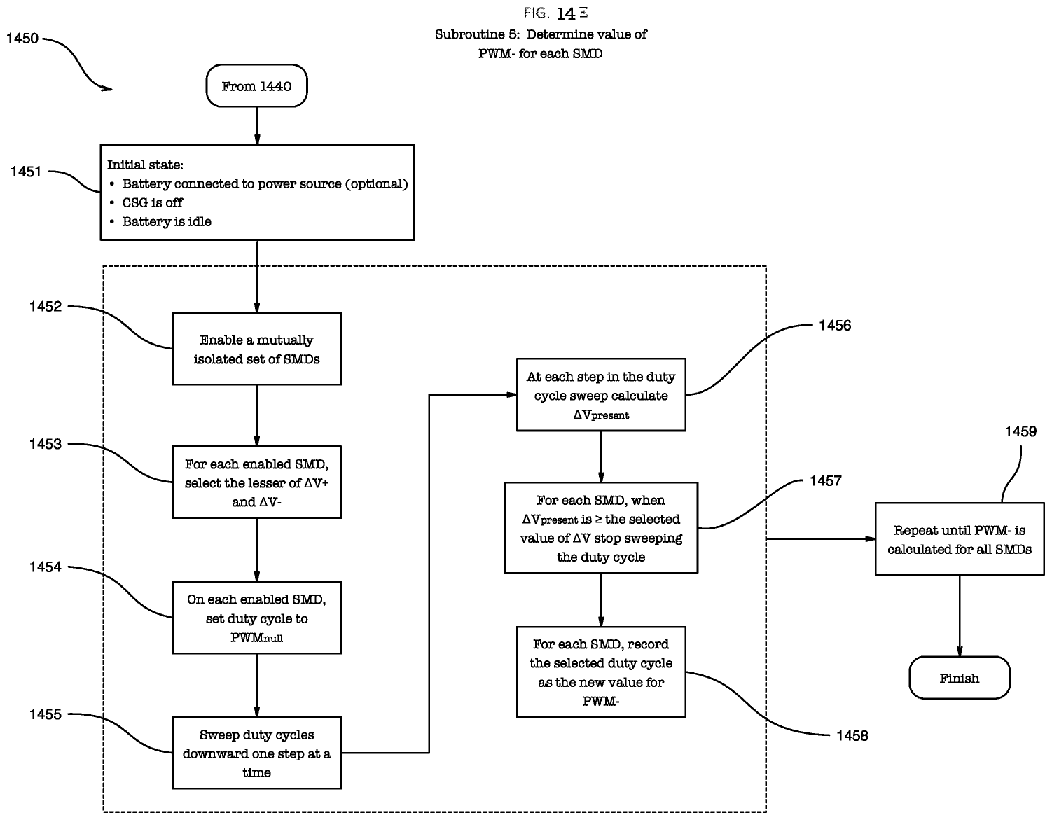

FIG. 14 illustrates the main method (1410-1450) that are performed to determine values of PWM+ and PWM−. As a non-limiting example, PWM+ and PWM− may be determined for each SMD (200) in a battery pack. For example, if a battery has 12 cells in series, there may be 11 SMDs, and values of PWM+ and PWM− will be determined for each of the 11 SMDs. Each of the main elements (1410-1450) in FIG. 14 are described in further detail in FIGS. 14a, 14b, 14c, 14d and 14e.

As shown in FIG. 14, the method to determine values of PWM+ and PWM− is:
1410: Determine the value of PWMₙᵤₗₗ (as defined above) for each SMD 400
1420: Apply positive reference current using a CSG 2001 and measure the voltage of each cell 16
1430: Apply negative reference current using a CSG 2001 and measure the voltage of each cell 16
1440: Calculate values of PWM+ for each SMD
1450: Calculate values of PWM− for each SMD

FIG. 14a illustrates an approach to determine value the value of PWMₙᵤₗₗ for each SMD 400 as follows:

At block 1411, turn off current on the primary charge path and disable all SMDS, so that there is no current into or out of the cells. At block 1412, measure voltage of each cell 16. This provides the value of zero-current voltage (VZ) of each cell 16. The values of VZ will be used in subsequent parts of the process.

Note that the balancing leg of each SMD 400 is connected to a junction between two cells: An upper cell 419 (closer to the positive terminal of the battery) and a lower cell 421 (closer to the negative terminal of the battery). At block 1413, for each SMD, calculate the ratio VZ_{lower}/(VZᵤₚₚₑᵣ+VZ_{lower}) where VZ_{lower} is the zero-current voltage of the lower cell and VZᵤₚₚₑᵣ is the zero-current voltage of the upper cell. Finally, at block 1414, for each SMD 400 determine the duty cycle that matches as closely as possible the value of VZ_{lower}/(VZᵤₚₚₑᵣ+VZ_{lower}) for the two cells associated with each SMD. Those duty cycles are the values of PWMₙᵤₗₗ for each respective SMD 400.

The actions taken at block (1420), as shown in FIG. 14, is to measure the cell voltages with a positive reference current. This is illustrated in FIG. 14b.

The initial state 1421 for measuring cell voltages with a positive reference current are: the battery 14 is connected to a power source; the CSG 2001 is off so that no reference current is being applied to the battery 14; and all SMDs 400 are disabled so that there is zero current on the balancing legs. At block 1422 the CSG 2001 applies a positive reference current on the primary charge path 402. In one or more embodiments of the invention, the magnitude of this positive reference current is at least half the threshold value for a maximum balancing current. At block 1423 the voltage of each cell 16 is measured while the positive current from the CSG 2001 is active. The voltage measurements taken at block 1423 are of the charge voltage of each cell 16, because the reference current is positive. At block 1424 a calculation of the absolute value difference between the charge voltage and zero-current voltage (VZ) of each cell is done. If the cells are numbered n=1 to N where N is the total number of cells, the voltage differences calculated at block 1424 may be denoted as ΔVn+. At block 1425 in FIG. 14b the values of ΔVn+ are stored, for example in system memory 22.

At block (1430) in FIG. 14 cell voltages are measured with a negative reference current as shown in detail in FIG. 14c.

The initial state for measuring cell voltages with negative reference current 1431 is similar to the initial state for measuring cell voltages with positive reference current 1421, with one difference. It is optional for the battery to be connected to a power source in order to generate a negative reference current. As a non-limiting example, the CSG 2001 can apply a known, characterized load to the battery to create a negative reference current, as is known to those with skill in the art.

At block 1432 the CSG 2001 applies a negative current on the primary charge path. As a non-limiting example, the magnitude of negative current will be at least half the threshold value of the maximum balancing current. At block 1433 the voltage of each cell 16 is measured while the negative (or discharge) current is active. The voltage measurements taken at block 1433 are of the discharge voltage of each cell, which may differ from the charge voltage of each cell. At block 1434 the absolute value difference between the discharge voltage and zero-current voltage (VZ) of each cell is calculated, analogously to how these calculations are done at block 1424, generating values that may be designated ΔVn−. At block 1435 in FIG. 14c values of ΔVn− are stored, for example in system memory 22.

The next action block (1440) in FIG. 14 is to calculate values of PWM+ for each SMD 400 as illustrated in FIG. 14d. The initial state 1441 requires the battery to be connected to a power source, the CSG to be off, the SMDs to be off (or disabled) and the battery to be idle. When these conditions are met, a subroutine may begin to calculate values of PWM+.

At block 1442, a set of mutually isolated SMDs 400 is enabled as defined above. On each of the enabled SMDs 400 two cells are connected to the end of each balancing leg, an upper cell 419 that is closer to the positive terminal 409 of the battery 14 and a lower cell 421 that is closer to the negative terminal 411 of the battery 14. When the PWM duty cycle is greater than PWMₙᵤₗₗ, the lower cell 421 will be charging, and the upper cell 419 will be discharging. For each SMD 400, recall the value of ΔVn+ (charging) for the lower cell 421 and the value of ΔVn− (discharging) for the upper cell 419. At block 1443, choose the lesser of the two recalled values for determining the value of PWM+. The selected value is called ΔV_{selected}.

At block 1444, the PWM duty cycle is set to a value that preferably is as close as possible to PWMₙᵤₗₗ. At block 1445 the duty cycle is swept upward, one step at time. When the duty cycle is swept upward from PWMₙᵤₗₗ, the balancing current will discharge the upper cell (419) and charge the lower cell (421). At block 1446, at each step in the upward sweep duty cycle the voltage of the cell associated with ΔV_{selected} is measured (as described above) and the absolute value difference between cell voltage at the present duty cycle and zero-current voltage for the cell is calculated. The absolute value difference is called ΔVₚᵣₑₛₑₙₜ because it is the voltage differential associated with the present value of the duty cycle. Blocks 1445 and 1446 are repeated until, at block 1447, ΔVₚᵣₑₛₑₙₜ is greater than or equal to the value of ΔV_{selected}. At block 1448 the duty cycle determined at block 1447 is stored in memory 22 as the new value for PWM+ for the respective SMD 400. Blocks 1443 to 1448 are performed on each of the mutually isolated SMDs that are selected at block 1442. Then another set of mutually isolated SMDs is selected 1442 and the process repeats until PWM+ has been calculated for all SMDs as shown at block 1449.

In FIG. 14, block (1450) calculates values of PWM− for each SMD 400. This is shown in detail in FIG. 14e.

The process for calculating values of PWM− 1450 are directly analogous to the sequence of actions for calculating PWM+ for each SMD 1440, with the following differences: For each SMD 400, recall from memory 22 the values of ΔVn− for lower of the two cells connected to the respective SMD 400 and the values of ΔVn+ for the upper of the two cells. Choose the lesser of those two values to be ΔV_{selected}, as shown at block 1453. The PWM duty cycle is swept downward (rather than upward), still starting at PWMₙᵤₗₗ, as shown at block 1455. In this case, the lower cell will be discharging, and the upper cell will be charging.

The final actions taken for determining values of PWM− (1457, 1458 and 1459) are identical to the final actions taken for determining values of PWM+ (1447, 1448 and 1449) as described above.

A numeric example of determining values of PWM+ and PWM− is now presented to further illustrate this process. The numbers presented in this example are for exemplary purposes and are non-limiting.

The battery in this example has two cells in series, one SMD and one associated balancing leg that is connected to the junction between the two cells. The lower cell in the series is designated cell 1. The upper cell in the series is designated cell 2. The maximum balancing current threshold is 10 A. Reference currents on the primary charge path are set at +5 A and −5 A. Each action block in this example will use the parameters set forth in this paragraph.

Block 1: Determine the value of PWMₙᵤₗₗ

In this example, the zero-current voltage of the upper cell (cell 2) is measured at 3.600V, and the zero-current voltage of the lower cell (cell 1) is measured at 3.800V. In this example the battery is out of balance, which helps to illustrate the process. PWMₙᵤₗₗ is calculated as the ratio VZ_{lower}/(VZᵤₚₚₑᵣ+VZ_{lower})=3.8/(3.6+3.8)=0.5135. Therefore, PWMₙᵤₗₗ is 51.35%. When a duty cycle of PWMₙᵤₗₗ is required, the system will use the closest duty cycle to 51.35% that it is capable of achieving.

### Block 2: Apply a Positive Reference Current and Measure Cell Voltages

A current of +5 A is applied to the primary charge path and cell voltages are measured. The corresponding upper and lower cells are measured to be 3.650V and 3.825V respectively. ΔVn+ for the upper cell (cell 2) is calculated as |3.650−3.600|=50 mV. ΔVn+ for the lower cell (cell 1) is calculated as |3.825−3.800|=25 mV. These values are then stored as differential voltages for cells 1 and 2 when a positive (charging) current is applied.

### Block 3: Apply a Negative Reference Current and Measure Cell Voltages

A current of −5 A is applied to the primary charge path and cell voltages are measured. The corresponding upper and lower cells are measured to be 3.570V and 3.790V respectively. ΔVn− for the upper cell (cell 2) is calculated as |3.570−3.600|=30 mV. ΔVn− for the lower cell (cell 1) is calculated as |3.790−3.800|=10 mV. These calculated values are then stored as differential voltages for cells 1 and 2 when a negative (discharging) current is applied.

Block 4: Sweep the SMD Upward from PWMₙᵤₗₗ to Determine the Value of PWM+

The CSG is turned OFF so that there is no current in the primary charge path. The PWM duty cycle is set as close as possible to 51.35% (the value of PWMₙᵤₗₗ). In this example, duty cycle closest to 51.35% may be 51%. Then increase the duty cycle to one step above 51%, which in this example may be 52%. This creates a positive (charge) current. In this case (with a positive current), the relevant differential voltages are ΔV− of cell 2 (30 mV) and ΔV+ of cell 1 (25 mV). The lesser of these two values is ΔV+ of cell 1 (25 mV). Therefore, 25 mV is the reference value to compare to as the duty cycle sweeps upward.

In this example, the voltage of cell 1 is equal to 3.805V when the duty cycle is at 52%. ΔVₚᵣₑₛₑₙₜ is calculated to be 3.805-3.800=5 mV. This value is less than 25 mV, so the process can be repeated. This means increasing the duty cycle another step and measuring voltage on the lower cell again. When the duty cycle reaches 55% as an example, the voltage of the lower cell is 3.827V and the corresponding value of ΔVₚᵣₑₛₑₙₜ is |3.827−3.800|=27 mV. In this example, this is the first measurement in which the value of ΔVₚᵣₑₛₑₙₜ is greater than or equal to 25 mV. The process of sweeping the PWM duty cycle can stop at this point. For this SMD, PWM+ can be set at either 55% or 54%. If an ample safety margin is associated with the threshold balancing current of 10 A, it may be safe to use a maximum duty cycle of 55%. If the safety margin is narrow or if it is desired to operate the system conservatively, PWM+ can be set at 54%, which will prevent balancing current from exceeding 10 A.

Block 5: Sweep the SMD Downward from PWMₙᵤₗₗ to Determine the Value of PWM−

The CSG is turned OFF so that there is no current in the primary charge path. The PWM duty cycle is set as close as possible to 51.35% (the value of PWMₙᵤₗₗ). In this example, duty cycle closest to 51.35% may be 51%. Then decrease the duty cycle to one step below 51%, which in this example may be 50%. This creates a negative (discharge) current. In this case (with a negative current), the relevant differential voltages are ΔV+ of cell 2 (50 mV) and ΔV− of cell 1 (10 mV). The lesser of these two values is ΔV− of cell 1 (10 mV). Therefore, 10 mV is the reference value to compare to as the duty cycle sweeps upward.

In this example, the voltage of cell 1 is 3.796V when the duty cycle is at 50%. ΔVₚᵣₑₛₑₙₜ is calculated as |3.796−3.800|=4 mV. This is less than 10 mV, therefore the process can be repeated. In this example, when the duty cycle reaches 48% the voltage of cell 1 is measured at 3.787V. Correspondingly, ΔVₚᵣₑₛₑₙₜ is |3.787−3.800|=13 mV. In this example, this is the first measurement in which the value of ΔVₚᵣₑₛₑₙₜ is greater than or equal to 10 mV. The process of sweeping the PWM duty cycle can stop.

Analogously to setting the value for PWM+, in this example the value of PWM− can be set at 49% or 48%, depending on the safety margin associated with maximum balancing current threshold and/or depending on how conservatively it is desired to operate the system. If there is ample safety margin associated with the 10 A threshold for balancing current, PWM− can be set to 48%. If the safety margin is narrow or if it is desired to operate the system conservatively, PWM− can be set to 49%.

This numeric example is for a battery with two cells in series and one SMD. The process for determining values of PWM+ and PWM− is the same for a battery with more cells in series and more SMDs. The values of PWM+ and PWM− can be determined by activating each SMD in the battery one-by-one, or by activating sets of mutually isolated SMDs and repeating the process until values of PWM+ and PWM− have been determined for each SMD in the battery.

The description and numeric example of calculating values for PWM+ and PWM− are non-limiting. For example, when sweeping the SMDs, it is possible to start at a duty cycle of 50% rather than starting at PWMₙᵤₗₗ. Or values of PWM+ and PWM− can be calculated alternately, rather than calculating all values of PWM+ first, and then calculating all values of PWM−. The CSG can be internal (i.e., part of the battery system), or external (i.e., part of the external charging power source). Those who are skilled in the art may use other variations on the process described above to calculate values of PWM+ and PWM− for a battery.

### Three Embodiments of PWM Limiting

Three embodiments of PWM limiting are described herein. One embodiment is static PWM limiting, in which PWM+ and PWM− are set as fixed values. In another embodiment, dynamic PWM limiting is disclosed, in which the values of PWM+ and PWM− are adjusted as the battery ages. A third embodiment disclosed is semi-dynamic PWM limiting, which falls between static PWM limiting and dynamic PWM limiting in terms of how frequently the values of PWM+ and PWM− are adjusted.

### Static PWM Limiting

In static PWM limiting, values of PWM+ and PWM− are determined for each SMD (400) in the battery 14. These values of PWM+ and PWM− are static for the life of the battery 14. The values of PWM+ and PWM− may be calculated when the battery 14 is new, for example, at the time the battery 14 is assembled or at the time the battery 14 is connected to the system it will be powering.

Two advantages of static PWM limiting are that it is simple and low cost. A disadvantage of static PWM limiting is that it does not determine new values for PWM+ and PWM− as battery system characteristics change over time.

### Dynamic PWM limiting

In dynamic PWM limiting, values of PWM+ and PWM− are recalculated (as described above) during the course of the life of the battery. Recalculation of the values of PWM+ and PWM− may occur at regular time intervals or at regular usage intervals (e.g., every 500 hours or every 1000 hours of battery use) or following a set number of charge/discharge cycles (e.g., every 100 charge/discharge cycles, or every 500 charge/discharge cycles), or if environmental conditions change, or may occur at irregular intervals. Recalculation also may also occur in any combination of the examples given above.

In a non-limiting example of an embodiment of dynamic PWM limiting, the CSG 2001 is internal (connected to the battery pack) rather than external (an element of an external power source). If the battery system has an internal CSG 2001, recalculation of the values of PWM+ and PWM− is not dependent on availability of an external power source that has a compatible CSG 2001.

An advantage of dynamic PWM limiting is that it re-calculates PWM duty cycle limits to reflect changes in the condition of the battery over time and/or changes in the environment in which the battery is operating. This advantage may come with the cost of an addition of a CSG 2001 to the system electronics, but the cost of the CSG 2001 may be lower cost than having a discrete current sensor on each balancing leg.

In other instances, the CGS 2001 may be external to the battery system. For example, the CSG 2001 may be part of an external power supply. Such an embodiment may result in a lower net cost of the battery system, but calculation of new values of PWM+ and PWM− may only occur when the battery is connected to a power source that includes a compatible CSG 2001. An embodiment such as this may be called semi-dynamic PWM limiting, as described further below.

### Semi-Dynamic PWM Limiting

In another embodiment of the invention, recalculation of values of PWM+ and PWM− may be performed at less frequent intervals than dynamic PWM limiting. For example, values of PWM+ and PWM− may be recalculated when an electric vehicle is brought to a service center. The service center may have a charging power supply that includes a CSG 2001 which allows recalculation of the values of PWM+ and PWM−. In such an instance it is not necessary for the battery system to have an internal CSG 2001. In an embodiment of semi-dynamic PWM limiting, calculation of values of PWM+ and PWM− may occur when the battery is connected to the external power source that includes the CSG 2001. Once connected to the power source, the process for performing characterization and calibration are identical to the process previously described. The external power source must establish a data communication channel with the battery management electronics to perform recalculation of PWM+ and PWM− and to allow the newly calculated values to be stored, for example in memory 22 in the battery management electronic system 18.

The embodiments of PWM limiting described above are non-limiting. Limiting the range of PWM duty cycles as a means of maintaining balancing current within a threshold may be achieved in other ways, such as setting a single value for PWM+ that applies to every SMD in the battery pack and setting a single value for PWM− that would also apply to every SMD in the battery pack. The salient point is that balancing current may be constrained (for example, to not exceed a threshold) by setting limits on the range of PWM duty cycles.

### Recalculating Values of PWM+ and PWM−

The process of recalculating values of PWM+ and PWM− may be performed under various temperature conditions and/or at various intervals over the life of the battery to correct or compensate for variations in battery condition caused by age and/or temperature.

Recalculation of values of PWM+ and PWM− can be done with a software or firmware algorithm or an equivalent interface. Calibration of an entire battery pack will typically take from a few seconds up to a few minutes depending on the size and condition of the battery.

PWM+ calculation can be performed at any time that a charging current source is available. PWM− calculation can be performed any time that a discharging current source is available. PWM+ and PWM− values can thus be updated at regular (or irregular) intervals in response to changes in conditions that occur during the life of the battery.

Comment on the performance of static PWM limiting over the life of the battery: As batteries age, impedance in the balancing circuits will increase. Cell impedance increases over time, and oxidation of the conductive materials in the circuit can increase circuit impedance over time. (There are exceptions to this, but they are rare and generally indicate a major fault condition such as breach of separator, or a short applied to the circuit. These rare fault conditions can be ignored in this analysis.)

Because impedance of the balancing circuits will increase over time, static PWM limits that are calculated early in the life of the battery (preferably when the battery is new) will result in a decline of maximum balancing current as the battery ages. Therefore, use of static PWM limits will not allow the balancing current to exceed the desired maximum (except for rare fault conditions, which will typically require battery repair or replacement) and, in general, the maximum balancing current will gradually decline over time in a battery system that uses static PWM limiting.

In one embodiment of the invention, static PWM limits will be calculated with the battery cooled to the low end of its rated temperature range. This condition will provide a worst-case condition of the balancing circuit at the time the PWM limits are calculated. It should be noted that in a worst-case condition the impedance is at its lowest state. This is because the conductive materials in the circuit (wires, connection plating, welds, etc.) will be at lower impedance with lower temperature. Cell impedance may increase at lower temperatures, but the lower impedance of the conductive material in the circuit may dominate the increase in impedance of the cells.

When the battery is warmer than the low temperature at which the static PWM limits were calculated, impedance of the balancing circuits will be higher. This assures that during the subsequent life of the battery, the maximum balancing current associated with the static PWM limits will be less than or equal to the balancing current that can occur under the conditions at which the static PWM limits were determined—i.e., at minimum rated temperatures of the battery and balancing circuits.

### Measurement of Cell Impedance

This section describes apparatus and methods to measure cell impedance utilizing current sensors that may be present in one or more embodiments of the system 18. There are two parts to the description of measuring cell impedance when current sensors are present: Wideband impedance measurement and narrowband impedance measurement.

### Wideband Impedance Measurement

One or more embodiments of the invention enable an apparatus and method for measurement of bipolar or unipolar charge and discharge impedance of each cell in a series stack of cells in a battery. These measurements can occur while the battery is charging, while it is discharging, or when the battery is in a quiescent state.

Referring again to FIG. 4: The controller 420 is interfaced to multiple SMDs 400, 414, and 416. System 18 allows measurement of individual impedances of cells 419, 421, 423, 425 in the series stack. If any of cells 419, 421, 423, 425 consist of a chain of individual cells connected in parallel, the parallel chains of cells are treated as one larger cell.

Impedances of cells 419, 421, 423,425 are measured in cell pairs (419-421,421-423, 423-425). Each SMD 400, 414, 416 is connected to two cells, an upper cell (most positive) and a lower cell (most negative). SMDs 400, 414, 416 are connected in an overlapping series string, so if SMDs 400, 414, 416 are simultaneously active the individual cell currents (409⇔408, 408⇔431, 431⇔433, 433⇔411) will be a function of the states of SMDs 400, 414, 416 and their respective cells. Therefore, to measure individual cell currents, each SMD must be isolated and treated individually. Individual cell currents can be measured using any reference current up to and including one half the maximum permitted balancing current, limited by the physical characteristics of each cell and the design limits of the SMD circuitry.

Impedances of individual cells can be measured by dividing cell voltage measurements by respective cell current measurements. Cell voltages can be measured with voltage sensors 410. Cell current measurements can be obtained from the current sensors 418 on the balancing legs 412. In one or more embodiments of the invention, cell voltage and cell current measurements can be taken periodically to determine impedance for each cell. These measurements can be taken at a desired rate or frequency, such as hourly, daily, weekly, etc. The voltage and current sensors enable the system to measure cell impedance while the battery is in use. For example, cell impedance can be measured while the battery is in a vehicle or in any other system or device that is battery-powered.

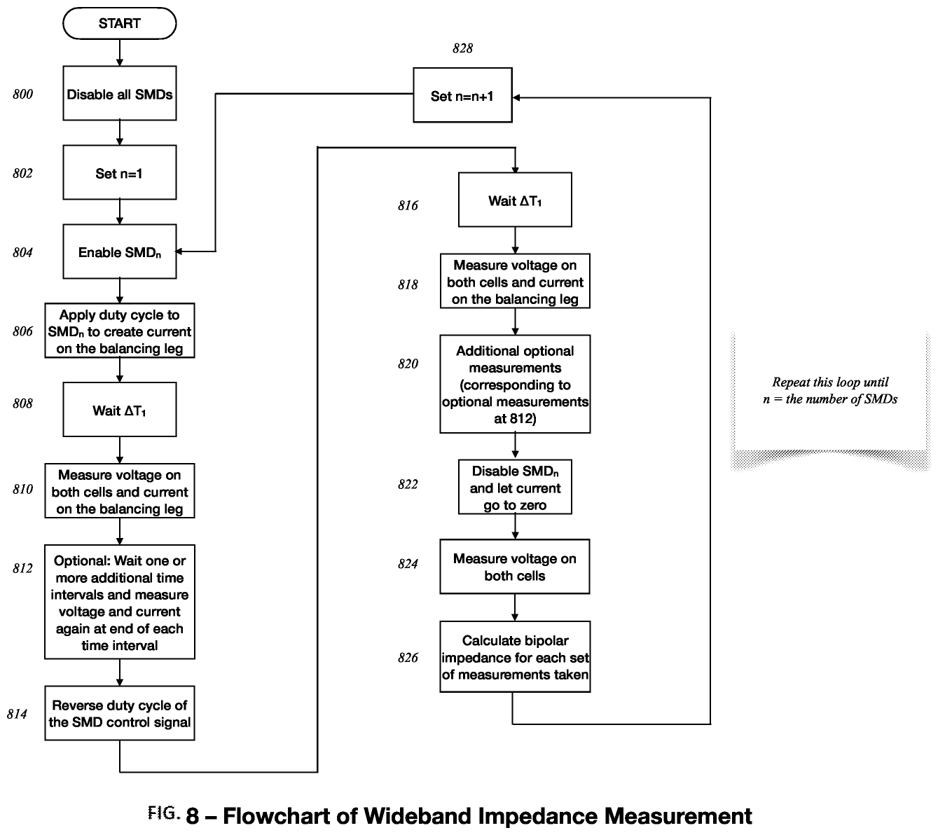

The method of taking these measurements is illustrated by the method shown in the flowchart of FIG. 8. The measurement process is as follows:
Block 1 (800)—Disable all SMDs 400, 414, 416. As a non-limiting example, SMDs can be disabled by setting a state in software that assures that both connections (switches) of each SMD 400, 414, 416 are open and the software will prevent PWM control signals from being sent to the SMDs 400, 414, 416. Disabling the SMDs assures that each of the balancing legs 412 has zero current.
Block 2 (802)—Select a first SMD, for example SMD 400, to use for cell impedance measurement
Block 3 (802)—Enable the selected SMD 400. As a non-limiting example, an SMD may be enabled by setting a state in the software that allows PWM control signals to be sent to the selected SMD 400.
Block 4 (806)—Apply a first SMD duty cycle to first SMD 400, creating a current on the respective balancing leg 412, a charge current in one of the connected cells and a discharge current in the other connected cell. This causes a rise in voltage in the cell receiving a charge current and a drop in voltage in the cell receiving a discharge current.
Block 5 (808)—Wait a fixed known time interval (as further described below) following activation of the SMD 400.
Block 6 (810)—Measure voltage on cells 419, 421 that are connected to SMD 400 and measure current on current sensors 417 and 442 on balancing legs 452 and 454. Note that the center balancing leg 412 carries the sum of the two cell currents. Currents for individual cells 419 and 421 may be measured on the upper balancing leg 452 and the lower balancing leg 454 respectively.
Block 6a (812)—Additional measurements of voltage and current of the cells that are connected to the SMD 400 can optionally be made following one or more subsequent time intervals as described below.
Block 7 (814)—Reverse the duty cycle of the control signal to the SMD 400 to reverse the charge and discharge currents to the two connected cells.
Block 8 (816)—Wait the same time interval as in Block 5
Block 9 (818)—Measure voltage on cells 419, 421 that are connected to SMD 400 and measure current on current sensors 417 and 442 on balancing legs 452 and 454, analogous to block 6.
Block 9a (820)—If additional measurements of voltage and current were made at block 6a (812), take additional measurements of voltage and current on the same time schedule as the measurements that were taken at block 5a (812).
Block 10 (822)—Disable the SMD 400 so that there is no charge or discharge current on the connected cells.
Block 11 (824)—Measure voltage on the two connected cells. This is measurement of cell voltage at zero current.
Block 12 (826)—Use Ohm's law (R=E/I) to calculate bipolar cell impedance. The charge cell impedance for each connected cell is calculated as the difference in cell voltage between voltage at charge current and voltage at zero current divided by the charge current.

Similarly, the discharge cell impedance for each connected cell is calculated as the difference in cell voltage between voltage at discharge current and voltage at zero current divided by the discharge current. If plural sets of measurements were taken at blocks 6a (812) and 9a (820), repeat these calculations for each set of measurements from blocks 6a (812) and 9a (820) that were taken at corresponding (or matching) time intervals following the start of the reference current.

These aspects of the process may be repeated for each SMD in the battery pack to obtain measurements of bipolar impedance for each cell in the stack, as indicated at block 828 in the flowchart.

When cells are manufactured, impedance measurements are typically made on each individual cell. For example, a cell manufacturer may measure DC resistance and AC impedance at 1 kHz on each cell. One or more embodiments of the invention can take wide bandwidth bipolar AC impedance measurements of cells in the series stack while the battery is being used in the end product, such as an electric vehicle. This allows cell impedance measurements to be performed over the entire life of the cells while the battery is being used in the field.

As a non-limiting example, to measure AC impedance at a frequency of 1 kHz: At 0.5 ms following the start of the positive reference current, measure voltage and current on both cells, then reverse the reference current. About 0.5 ms after reversing the reference current, measure voltage and impedance of both cells again. Then disable the SMD and measure voltage of both cells with zero current. Then calculate bipolar impedance using Ohm's Law as described at block 12 (826).

Multiple measurements of voltage and current during each interval of reference current (positive and negative) allow calculations of AC impedance at more than one frequency. For example, if measurements are taken 0.5 ms following the start of each reference current interval, these measurements will yield values for 1 kHz AC impedance. If additional measurements are taken 1 ms following the start of each reference current interval, these measurements will yield values for 500 Hz AC impedance.

In one or more embodiments of the invention, cell impedances at a plurality of frequencies can be characterized, from DC to any higher frequency that is adequately lower than the SMD switching frequency and also adequately lower than the resonant frequency of the SMD filter. As a non-limiting example, SMD switching frequencies may range from 100 kHz to 400 kHz in one or more embodiments of the invention that may have a maximum balancing current of approximately 4 A. A ratio of about twenty to one (between SMD switching frequency and impedance frequency) may provide adequate accuracy. For a nominal 200 kHz SMD system, impedance measurements can be made from DC to about 10 kHz (200 kHz/20).

The resonant frequency of the SMD LC filter will affect the ripple level of the SMD output current. A typical LC filter for use with a 200 kHz SMD can have a resonant frequency of approximately 8 kHz, as a non-limiting example. Impedance frequencies adequately lower than the filter resonant frequency may provide higher signal levels for the cell voltage and current measurements. For this example, an LC filter resonant frequency of 8 kHz may provide adequate AC signal levels for impedance measurements up to 2 kHz. Cell voltage measurements may have a bandwidth from five to ten times the highest desired impedance frequency to provide adequate voltage measurement accuracy. For example, to measure impedance at frequencies up to 1 kHz, voltage sensors may have a bandwidth of 5 kHz to 10 kHz to provide adequate accuracy. Relationships between filter frequency response and signal levels are well understood in the art of signal processing.

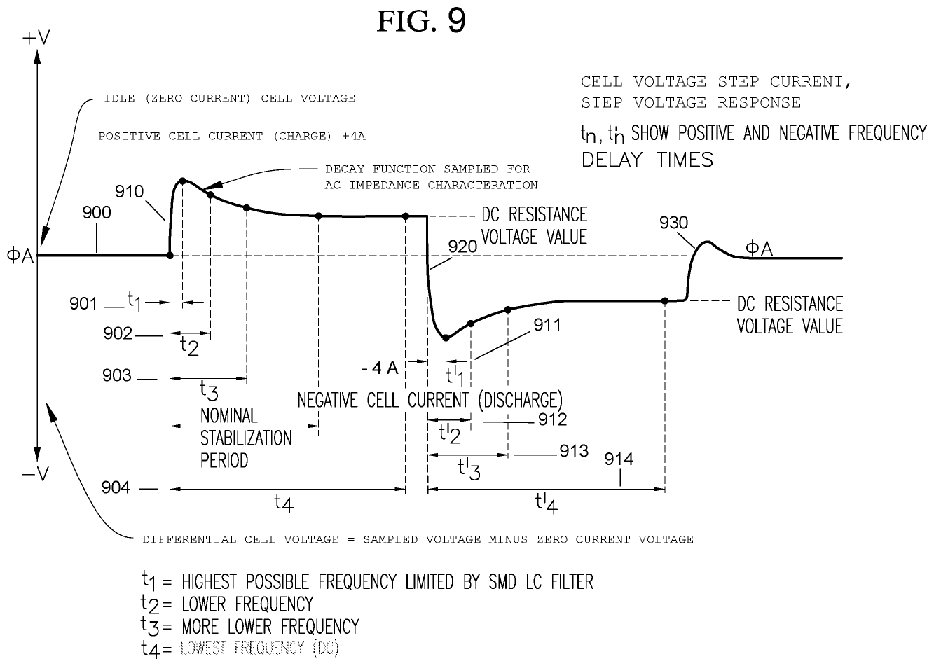

FIG. 9 illustrates an exemplary voltage waveform 900 that may be generated by the impedance measurement method described above. The voltage waveform 900 shows non-limiting examples of characteristic rise 910 and fall 920 and relaxation 930 in voltage that occur when actions 4 (806), 7 (814) and 10 (822) are performed. The voltage waveform 900 applies to a connected cell that receives a positive charge at block 4 (806). The curve for the other connected cell will be approximately an inverse of the curve in FIG. 9 but will not be an exact inverse as each cell has different characteristics.

FIG. 9 further illustrates non-limiting examples of timing of the measurements of voltage and current that may be taken to calculate cell impedance in one or more embodiments of the invention. After a first positive duty cycle is applied at block 4 (806), a first set of measurements may be taken at the time indicated as T₁ (901). This measurement is taken at the peak of the voltage pulse, and may represent a highest frequency measurement that may provide calculation of cell impedance that has practical accuracy. The duration of time interval T₁ (901) is typically determined by the frequency of the LC filter as described above.

Another measurement may be taken at time T₂ (902). To measure AC impedance of 1 kHz, the duration of time interval T₂ (902) may be 0.5 ms. Yet another measurement may be taken at time T₃ (903). To measure AC impedance of 500 Hz, the duration of time interval T₃ (903) may be 1.0 ms.

The duty cycle is reversed at block 7 (814) and the waveform essentially inverts 920. A new set of measurements may be taken at time intervals shown as T′₁ (911), T′₂ (912) and T′₃ (913). These time intervals will typically be equal or nearly equal to corresponding time intervals T₁, T₂ and T₃ (901, 902 and 903 respectively).

As another non-limiting example, to measure cell DC resistance: Start the first (positive) reference current 910. Wait a sufficient amount of time to allow the slope of the voltage decay curve to become close to zero. This is shown as time interval T₄ (904). This amount of time is called the DC stabilization period. The DC stabilization period will vary depending on parameters such as cell chemistry and size of the cells as well as the SMD LC filter frequency. Note that the voltage decay curve is asymptotic to zero slope. In theory the voltage decay curve never reaches a slope of zero. In practice, the DC stabilization period T₄ (904) can be set to a duration that assures that the slope of the voltage decay curve is close enough to zero to yield a meaningfully accurate measurement of DC resistance of the cells. Those skilled in the art are able to comprehend this detail and all technical matters regarding this aspect of the invention at the time of filing based on his/her own knowledge.

When the DC stabilization period T₄ (904) has transpired, measure voltage and current on cells 419 and 421. Reverse the reference current 920 and wait again for the DC stabilization period T′₄ (914) to transpire. Then measure voltage and current on cells 419 and 421 again. Next, disable the SMD and let current go to zero (822 in FIGS. 8 and 920 in FIG. 9). Measure voltage on both cells with zero current, then perform the calculations as described at block 12 (826) to determine bipolar DC resistance of the cells.

For example, if a maximum balancing current of 8 Amperes has been established for a specific battery system, then impedance measurements can be made with reference currents of positive 4 Amperes and negative 4 Amperes. In general, the greater the reference current, the greater the accuracy of impedance measurement, so typically the maximum supported balancing current will be applied as approximately one half the reference current for measuring cell impedance. However, reference currents less than one half maximum balancing current can be used.

If the target reference current is 4 Amperes, for example, it is not necessary for the actual reference current to be exactly 4 Amperes. The balancing system 18 is able to modulate the SMDs 400 to create a balancing current of approximately 8 A, and then actual current is measured using the respective current sensor to calculate impedance. Similarly, the positive and negative reference currents do not need to be identical in magnitude; they just need to be similar to each other to allow a sufficiently accurate calculation of bipolar impedance. As a non-limiting example, a difference of ±10% in magnitude between the positive and negative balancing currents may allow sufficiently accurate calculation of impedance.

The sequence in which reference currents are applied does not need to be the exact sequence described above. For example, the first reference current can be zero, followed by a positive and then negative reference current. Or a positive reference current can be applied, followed by zero reference current, and finally negative reference current. Note that “positive” and “negative” are relative terms in this description. A positive current to one of the connected cells will be a negative current to the other connected cell. That does not affect this description, because for every set of bipolar impedance measurements, both connected cells will experience positive, negative and zero reference currents. The application of positive and negative current will be opposite for the two cells; the application of zero current will be the same for both cells.

In another embodiment, unipolar impedance measurements may be desired. For unipolar impedance, the polarity (charge/discharge) of each cell current can be applied in the same direction, either charge or discharge. For example, instead of reference currents of positive 4 Amperes and negative 4 Amperes, the active SMD may be set to modulate positive 5 Amperes and positive 1 Ampere for one cell and negative 5 and negative 1 Ampere for the other cell. The unipolar embodiment enables cell impedance to be measured when the cell is not crossing back and forth between charge and discharge states.

By taking multiple measurements (either unipolar or bipolar) during each reference current interval, it is possible to capture data that can be used to approximate the shape of the voltage decay curves of the cells. This is useful (in addition to the utility of capturing individual impedance measurements) as it provides information on how the voltage decay curves change as the battery is used and as the battery ages.

This concludes the description of wideband impedance measurement.

In some battery systems wideband impedance measurement may be impracticable. This may be the case if the signal-to-noise ratio of the voltage signal is low. In such cases, narrowband impedance measurement as described in the following section may be a preferable means of determining cell impedance.

### Narrowband Impedance Measurement

A description of noise that may be present in the AC waveform is now presented, as is a description of how filtering may reduce the noise and improve signal-to-noise ratio (SNR).

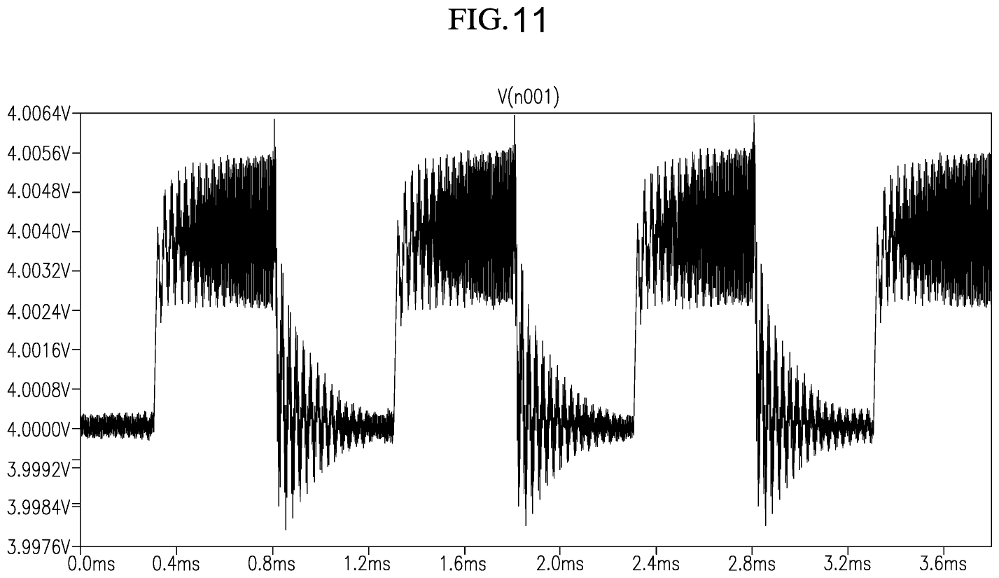

The voltage signal at each cell and the excitation current on the balancing leg may be a waveform at the fundamental frequency of the excitation current. This waveform may have harmonics, SMD ripple and noise at frequencies which may be above and/or below the fundamental frequency of the impedance measurement. FIG. 11 shows an example of a plot of a voltage signal in which such sources of noise are present. With conditions such as this, it may be difficult to obtain impedance measurements of practical accuracy because of the amount of noise in the voltage signal.

Noise at frequencies that are higher than the fundamental frequency of impedance measurement may be reduced by passing the voltage and current signals through a low pass filter having a corner frequency approximately equal to or slightly greater than the impedance measurement frequency.

If noise signals are present below the fundamental frequency, a high pass filter may be alternatively or additionally employed to likewise reduce lower frequency components.

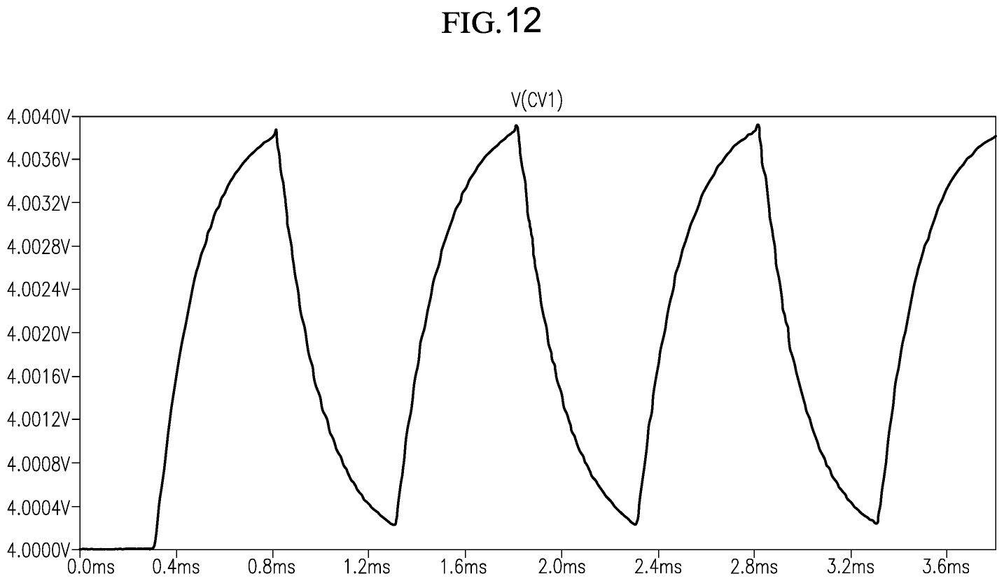

A bandpass filter may be employed to reduce noise at frequencies both above and below the fundamental frequency. The narrower passband created by the use of such filters can remove a large portion of the higher noise and harmonic frequencies and/or the lower noise frequencies. This can provide improved signals of cell voltage at the fundamental frequency, which can increase the signal-to-noise ratio (SNR) of voltage measurements. FIG. 12 illustrates how the voltage signal of FIG. 11 may look after bandpass filtering. Those with skill in the art are able to comprehend this detail and all technical matters regarding this aspect of the invention at the time of filing based on his/her own knowledge.

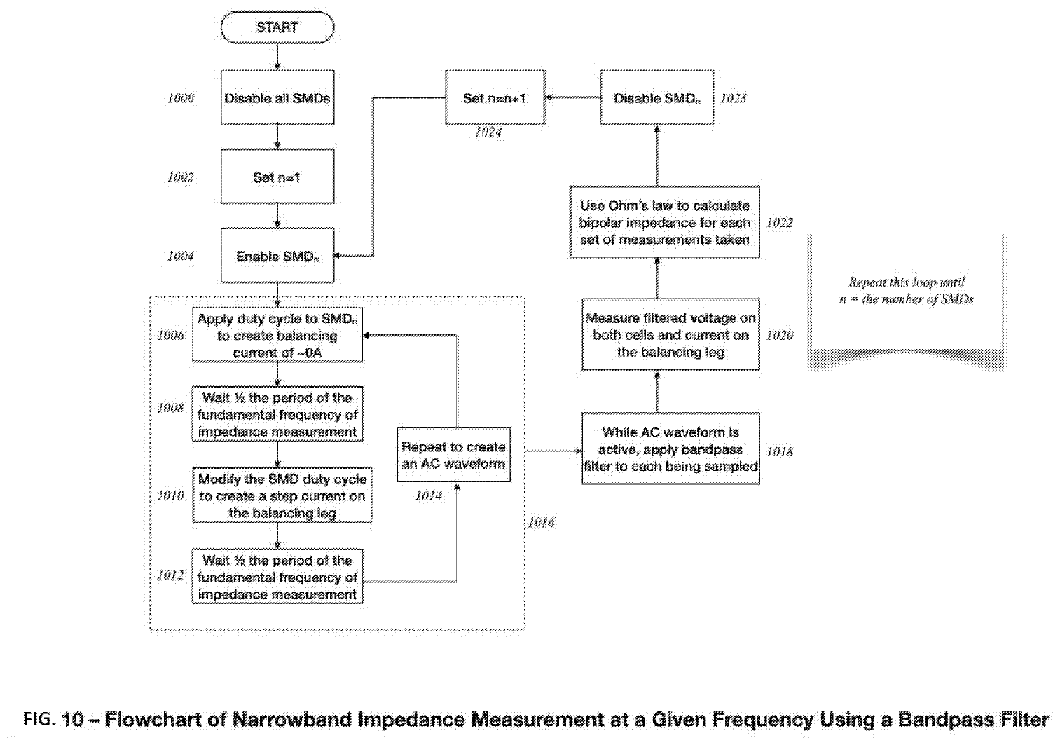

FIG. 10 describes a method for measuring bipolar impedance of cells at a single frequency using a narrowband impedance measurement method to improve the signal-to-noise ratio of the voltage signal. Measuring at a single frequency (narrowband) improves the signal-to-noise ratio (SNR) of measurements of cell voltage and current. Improvement in SNR by reduction of bandwidth is well known in the art of signal processing technique.

Referring to FIG. 10, measurement of narrowband bipolar impedance of cells at a single (fundamental) frequency can be performed as follows:
Block 1 (1000)—Disable all SMDs as previously described, which brings all balancing legs to zero current.
Block 2 (1002)—Select a first SMD 400 to use for cell impedance measurement
Block 3 (1004)—Enable the selected SMD as previously described
Block 4 (1006)—Apply a first duty cycle to SMD 400 to create a balancing current of approximately 0 A. If the voltages of the two respective cells 419 and 421 are nearly equal, a duty cycle of 0.5 (50% duty cycle) may create a balancing current of nearly 0 A. If a duty cycle of 0.5 does not create a balancing current that is nearly 0 A (which may be determined by sampling the current sensor 418) the duty cycle may be adjusted up or down to find a duty cycle that creates a balancing current as close as possible to 0 A.

When the balancing current is at or near zero, the average current in each of the two cells 419 and 421 will also be at or near zero. The average voltage of each cell 419 and 421 is now approximately equal to the voltage of the cells 419 and 421 when the SMD is disabled.
Block 5 (1008)—Maintain this duty cycle for one half the period of the fundamental frequency of the impedance measurement. For example, if impedance measurement is at 1 kHz, the fundamental frequency is 1 ms, so this duty cycle is maintained for 0.5 ms.
Block 6 (1010)—Adjust the SMD duty cycle to create a step current on the balancing leg 412, which creates a charge current in one of the connected cells and a discharge current in the other connected cell. This causes arise in voltage in the cell receiving a charge current and a drop in voltage in the cell receiving a discharge current.
Block 7 (1012)—Maintain this duty cycle for one half the period of the fundamental frequency of the impedance measurement.

Repeat steps 4 (1006) through 7 (1012) continuously. This creates an alternating current between the zero current state and the charge/discharge current state. This pattern of SMD modulation will create a continuous excitation current in the two cells at a fundamental frequency that is determined by the sum of the two periods of the switching states in steps 5 (1008) and 7 (1012), one cell switching from zero current to charge current and the other cell switching from zero current to discharge current. Box 1016 encompasses the aspects of the process that create the AC waveform.
Block 8 (1018)—While the AC waveform is active, apply filtering to the voltage waveform, which can be high pass or low pass or bandpass filtering.
Block 9 (1020)—Measure the filtered RMS voltage on the respective cells 419 and 421 and the RMS current on current sensors 417 and 442 on respective balancing legs 452 and 454.
Block 10 (1022)—Use Ohm's law (R=E/I) to calculate bipolar cell impedance as previously described.
Block 11 (1023)—After impedance is calculated at block 10, disable the SMD that was just used for calculating cell impedance.

Blocks 1 through 11 may be repeated for each SMD in the battery stack, as indicated at block 1024.

Because the current and voltage signals are AC waveforms, the RMS value of each may provide a more accurate calculation of impedance. In one or more embodiments, precise reference resistors inserted in series with the cells or in place of the cells to generate reference levels of impedance and voltage.

As is described in the description of wideband impedance measurements, the charge and discharge currents that are measured using narrowband impedance measurement may not be precisely equal because SMD operation will have some small finite energy loss. In order to improve the accuracy of measurements of charge/discharge impedance, the SMD duty cycle that is generated at block 4 (1006) may be reversed in order to reverse the excitation current signals so that the charge and discharge directions for the two cells are reversed. The two voltage measurements of each cell 419 and 421 and the excitation current may then be averaged, peak detected or otherwise filtered to improve the accuracy of the impedance calculation, as will be well known to those skilled in the art.

While employing a sampling system to measure signal amplitude of the fundamental frequency of impedance measurement, the sampling rate must exceed the desired resolved fundamental frequency according to the Nyquist criterion.

### Cell Impedance Measurement Using a Current Signal Generator

The methods of obtaining cell impedance disclosed in the preceding section rely on presence of current sensors on the balancing legs. However, some embodiments of the system 18 may not have current sensors on the balancing legs. In such embodiments it may be advantageous to be able to obtain data on cell impedance. Herein are disclosed methods and apparatus for obtaining data on cell impedance that doesn't require current sensors on the balancing legs. These methods and apparatus may be used to obtain data on cell impedance in any battery, regardless of whether it has or does not have a balancing system.

Here is a high-level description of these methods and apparatus: A current signal generator (CSG) generates known reference currents. When a reference current is applied to the battery, data are captured from voltage sensors connected to the cells in the battery. Then Ohm's Law may be applied to the values of current and voltage to calculate cell impedance.

The reference current can be direct current (DC) to calculate DC resistance of the cells; or can be alternating current (AC) to calculate AC impedance of the cells.

One or more embodiments the system for calculating cell impedance may have one or more bandpass amplifiers to increase the signal-to-noise ratio of cell voltage signals and/or to increase the strength of the cell voltage signals.

In other embodiments, multiplexers that can provide a single output from a plurality of inputs, can be placed between the voltage sensors and bandpass amplifiers which may reduce the number of bandpass amplifiers that are needed.

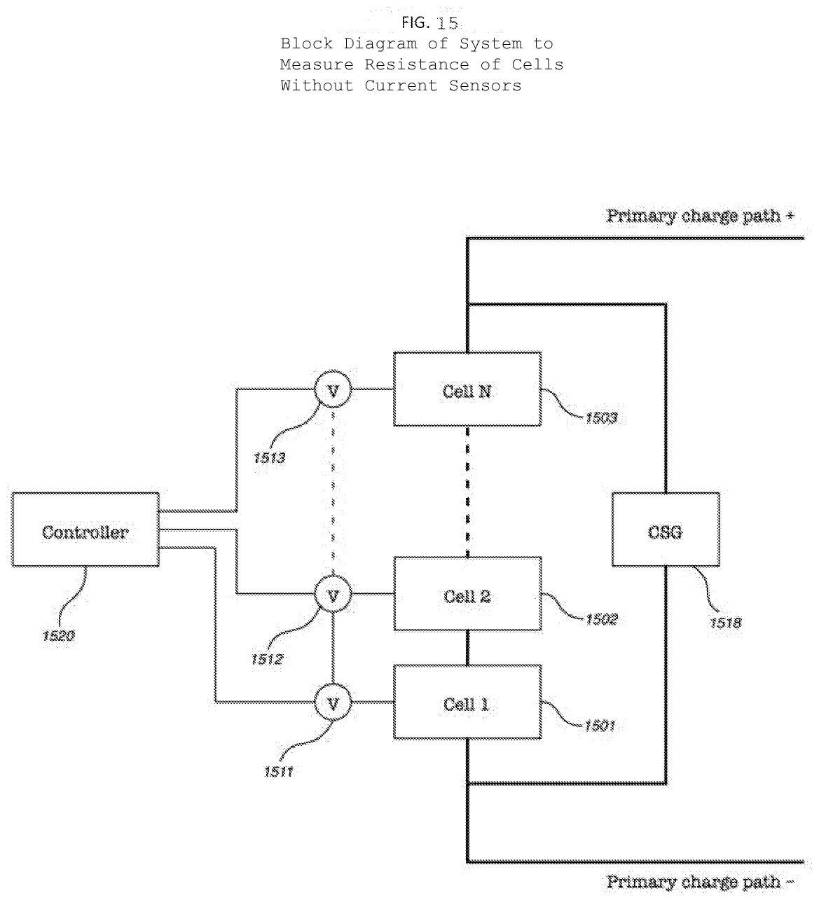

The methods and apparatus for determining cell impedance using a CSG are now described in detail and are illustrated in FIGS. 15, 16, 17 and 18.

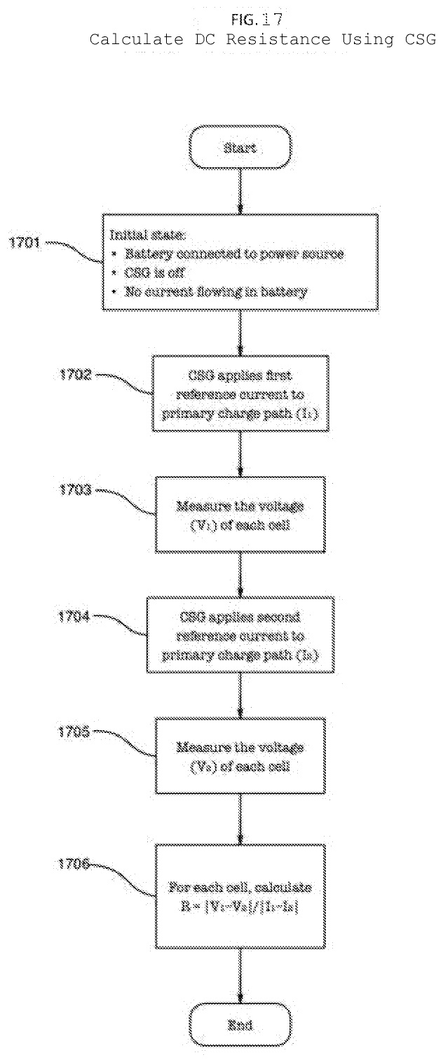

FIG. 15 illustrates a system that may be used to calculate DC resistance of cells using a CSG. Shown in FIG. 15 is cell 1 (1501), cell 2 (1502), cell N (1503) voltage sensors 1511, 1512, 1513. controller (1520) and a CSG (1518). A battery consists of N cells that may be numbered from Cell 1 (1501) at the bottom of a set of cells connected in series; to Cell 2 (1502) immediately above Cell 1 (1501) in the series; and continuing up to Cell N (1503) which is the top cell in the series. A voltage sensor is connected to each cell. For example, a first voltage sensor (1511) is connected to Cell 1 (1501); a second voltage sensor (1512) is connected to Cell 2 (1502); up to an Nth voltage sensor (1513) connected to Cell N (1503). It should be noted that CSG (1518) has an electrical connection to the primary charge path at the positive and negative terminals of the battery. A GSG connected to the primary charge path can generate known and selectable reference currents (e.g., +5 A or −5 A or +10 A or −10 A). In addition, the CSG (1518) has a data connection (not shown in FIG. 15) to a controller (1520) and the voltage sensors (1511, 1512 . . . , 1513) also have data connections to the controller (1520) that are not shown in FIG. 15. The controller (1520) may receive values of reference currents generated by the CSG (1518) and values of cell voltages generated by the voltage sensors (1511, 1512 . . . , 1513) and may use those received values of current and voltage to calculate DC resistance of each cell in the series stack as further described in FIG. 17.

FIG. 17 is a flowchart that illustrates the process of calculating cell DC resistance using a CSG 1518 (i.e., without relying on presence of current sensors connected to each cell in the battery).

The battery is connected to CSG (1518) as described above. The CSG (1518) may provide a reference current on the primary charge path. The reference current may be positive or negative. The CSG (1518) may be able to generate positive reference currents or negative reference currents or both positive and negative reference currents. At block (1701) of the process depicted in FIG. 17 the battery is connected to a power source and during this initial state (1701) the CSG (1518) is OFF, which means that there is zero current or close to zero current flowing in or through the battery. At block (1702), the CSG (1518) applies a first reference current (I₁) to the primary path. Block (1703) involves measuring the voltage (V₁) of each cell. While the first reference (I₁) current is active, the controller (1520) captures a value of a first voltage (V₁) at each cell in the battery (1502, 1502, 1503). Next (1704), the CSG (1518) applies a second reference current (I₂) to the primary charge path. The next step (1705) in FIG. 17 shows that while the second reference current (I₂) is active, the controller (1520) captures a value of a second voltage (V₂) at each cell in the battery (1501, 1502, 1503). Next the controller (1520) uses the data described above to calculate the DC resistance of each cell in the battery via Ohms law, R=|V₁−V₂|/|I₁−I₂|.

A numeric example is set forth herein. For reference currents of 10 A and 1 A, the voltage measurement at 10 A is V₁=10 mv and the voltage measurement at 1 A is V₂=1 mV. The differential voltage is |10 mv−1 mv|=9 mV and the differential current is |10 A−1 A|=9 A. Therefore, the calculated DC resistance is 9 mV/9 A=1 mΩ. This calculation of DC resistance can be performed on each cell in the series stack. If the battery architecture has a chain of cells connected in parallel, each parallel chain is then treated as one large cell. It should be noted that resistance or impedance calculations are not performed on each individual cell in a parallel chain.

This process can also be performed with negative reference currents. Using negative reference currents allows determination of discharge impedance of the cells. Typically, the charge impedance of a cell will be different from the discharge impedance. Note that in this context, “impedance” may refer to DC resistance and/or AC impedance.

This concludes the description of how DC resistance of cells in a battery may be determined using a CSG. Next is a description of how AC impedance of cells in a battery may be determined using a CSG.

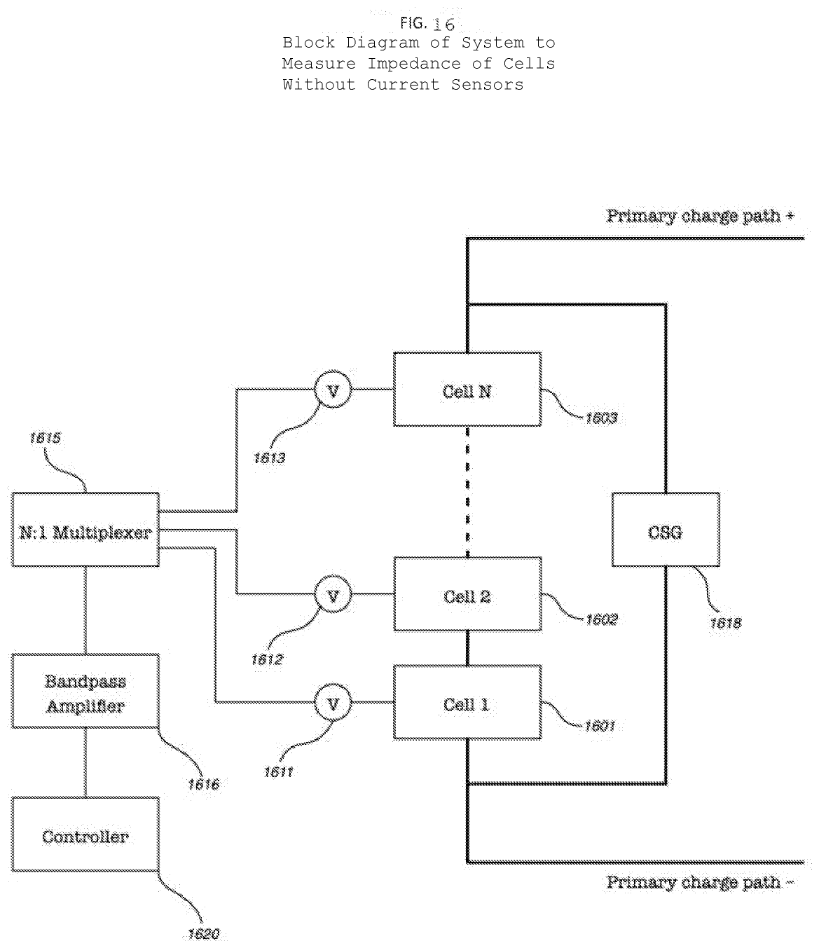

FIG. 16 is a block diagram of a system that may use a CSG to calculate AC impedance of cells in a battery. The figure shows an N to 1 multiplexer (1615), a bandpass amplifier (1616), a controller (1620), voltage sensors (1611, 1612 and 1613), cells 1 to N (1601, 1602, and 1603) and CSG (1618). A battery consists of N cells that may be numbered from Cell 1 (1601) at the bottom of a set of cells connected in series; to Cell 2 (1602) immediately above Cell 1 (1601) in the series; and continuing up to Cell N (1603) which is the top cell in the series. A voltage sensor is connected to each cell. For example, a first voltage sensor (1611) is connected to Cell 1 (1601); a second voltage sensor (1612) is connected to Cell 2 (1602); up to an Nth voltage sensor (1613) connected to Cell N (1603). The CSG (1618) has an electrical connection to the primary charge path at the positive and negative terminals of the battery. It should be noted that the term “primary charge path” is intended to be non-limiting. It may also function as a discharge path when the battery is powering a load. The GSG (1618) can generate known and selectable AC reference currents at known and selectable frequencies (e.g., 100 Hz or 1 kHz) as further described below.

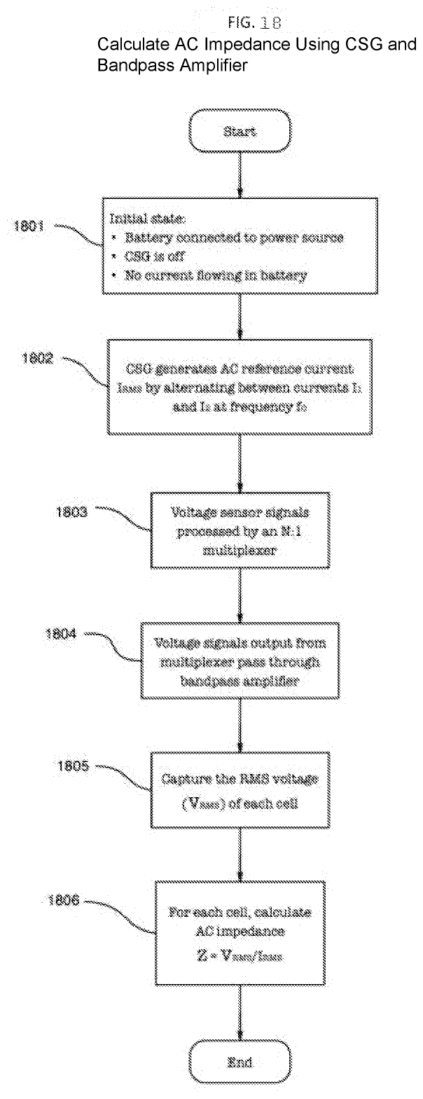

The CSG 1618 has a data connection (not shown in FIG. 16) to a controller 1620. In one or more embodiments, the voltage sensors (1611, 1612 . . . , 1613) may be connected to a multiplexer 1615 that receives voltage signals from the voltage sensors (1611, 1612 . . . , 1613). The multiplexer (1615) may output one voltage signal at a time in a controlled manner to a bandpass amplifier (1616) which provides bandpass filtering (as further described below) and signal amplification to the voltage signals. The bandpass amplifier 1616 outputs voltage signals to a means for receiving voltage signals, such as an analog-to-digital input on a controller 1620. The controller (1620) may use values of reference currents generated by the CSG (1618) and may use values of the filtered and amplified data from the voltage sensors (1611, 1612 . . . , 1613) to calculate AC impedance on each cell in the series stack as described in FIG. 18.

FIG. 18 is a flowchart that illustrates a method of calculating AC impedance values for cells in a battery. In the initial state (1801) the battery is connected to a power source and the CSG (1518) is OFF, so that minimal or no current is flowing in or through the battery.

At block 1802 the CSG (1518) generates an AC reference current on the primary charge path. To generate an AC reference current at a specific frequency f₀ (for example 100 Hz or 1 kHz) the CSG (1518) will generate two reference currents and will toggle between the two currents at the specified frequency f₀. An AC voltage waveform associated with f₀ will be generated at voltage sensors (1611, 1612, 1613). In one or more embodiments, the voltage signals are routed to a multiplexer (1615) as shown at block (1803). If the battery has N cells in series, an N:1 (N to 1) multiplexer (1615) may be employed. Use of a multiplexer to manage multiple input signals is well known to those who are skilled in the art.

The multiplexer (1615) may output signals from voltage sensors (1611, 1612, 1613) to a bandpass amplifier (1616) one at a time in a known and controlled manner as shown at block (1804). The bandpass amplifier (1616) may have a center frequency f₀ which corresponds to the frequency of AC impedance to be measured. Further, the bandpass amplifier (1616) will produce a sinusoidal (or quasi-sinusoidal) output with root mean square (RMS) value proportional to the RMS amplitude of the AC reference current. In addition, the bandpass amplifier (1616) can bring the analog voltage signals up to a level that can more accurately be read by the analog signal receiving means, for example an analog-to-digital input on the controller (1620) or an equivalent method or apparatus. The bandpass amplifier (1616) must have a bandwidth sufficiently narrow to effectively reject noise signals above and below the reference frequency f₀. Noise rejection using bandpass amplifiers (1616) is well known to those skilled in the art.

At block (1805) in FIG. 18 the output signals from the bandpass amplifier (1616) are captured by a signal receiving means such as analog-to-digital input or an equivalent method or apparatus associated with the controller (1620). Finally, AC impedance may be calculated as the quotient of the RMS voltage values divided by the RMS value of the reference current.

In one or more other embodiments a system for determining AC impedance of cells in a battery can be made without a bandpass amplifier (1616) if it is determined that the signal strength and the signal-to-noise ratio of the voltage signals are sufficiently high to allow direct connection to analog signal receiving means.

In other embodiments that use bandpass amplifiers (1616), each voltage sensor (1601, 1602,1603) may be connected to a separate bandpass amplifier (1616), i.e., eliminating the multiplexer 1615.

An example of calculating AC impedance is set forth herein. For an AC reference current of 10 A_{RMS} at a frequency f₀, Bandpass amplifier voltage at the AC reference current of 10_{ARMS} is V1=10 mV_{RMS} at frequency f₀. Applying Ohm's Law, Z (impedance)=10 mV_{RMS}/10 A_{RMS}=1 mΩ at frequency f₀.

It should be noted that this method of calculating cell impedance is compatible with any battery with any kind of balancing system and is applicable to batteries that do not have balancing systems. If a balancing system is present, the balancing system must be disabled while calculating cell impedances using the method described above. This method of calculating cell impedance can be performed with a CSG (1618) that is part of the battery system or with a CSG (1618) that is external to the battery system or an equivalent configuration such as a component of an external power source.

It will be appreciated that the description provided herein has been given with reference to some example embodiments, these are not intended to be limiting, and that various alternative arrangements may be used to implement the subject matter claimed herein. The claims and the full scope of their equivalents are what describe one or more embodiments of the invention.

What is claimed is:

1. An assembly, comprising:
at least one switch mode divider (SMD) connectable in parallel to a junction between two respective battery cells connected in series, and operable to equalize voltages among plural battery cells based on signals from at least one voltage sensor, the SMD being characterized by an output voltage Vo that is a function of a duty cycle of a drive waveform and high and low rail voltages; and
at least one circuit that generates a signal representative of current on a balancing leg associated with the at least one SMD to enable the SMD to limit current from the SMD to at least one of the battery cells during charging.

2. The assembly of claim 1, wherein the circuit comprises a current sensor that generates the signal based on current sensed by the current sensor.

3. The assembly of claim 1, wherein the circuit comprises a controller that generates the signal based on an estimation of current.

4. The assembly of claim 3, wherein the controller uses Ohm's law to estimate the current.

5. The assembly of claim 3, wherein the controller modulates the at least one SMD based on the estimation to limit current through at least one balancing leg associated with the at least one SMD to be no more than a threshold current magnitude.

6. The assembly of claim 5, wherein the threshold current magnitude is a second threshold current magnitude, and wherein the second threshold current magnitude is a predetermined amount less than a first threshold current magnitude at which battery cell stress may occur.

7. The assembly of claim 6, wherein the controller is preprogrammed with the second threshold current magnitude.

8. The assembly of claim 3, wherein the estimation of current is based at least in part on at least one estimation of impedance for at least part of the assembly.

9. The assembly of claim 8, wherein the estimation of impedance is based at least in part on at least one temperature coefficient to estimate change in impedance at a given temperature.

10. The assembly of claim 9, wherein temperature is sensed for estimating changes in impedance due to changes in temperature using at least one temperature sensor in the assembly.

11. The assembly of claim 10, comprising at least one temperature sensor and comprising the plural battery cells.

12. The assembly of claim 11, wherein the temperature sensor senses temperature of electronics.

13. An apparatus, comprising:
at least first and second battery cells arranged in electrical series with each other and defining a primary charge/discharge path;
a balancing circuit arranged in electrical parallel with the primary charge/discharge path, the balancing circuit comprising:
a voltage sensor line and;
at least one cell junction between respective adjacent battery cells connected in series;
at least one voltage sensor; a respective switch mode divider (SMD) connected to a respective cell junction; and
at least one controller controlling the respective SMDs to equalize voltages among battery cells.

14. The apparatus of claim 13, comprising:
a respective current sensor electrically connected to a respective balancing leg and useful to enable the respective SMD to limit current through the respective balancing leg to which the current sensor is connected.

15. The apparatus of claim 13, wherein the controller controls the respective SMD to limit current through the respective balancing leg based on an estimation of current in the respective balancing leg.

16. The apparatus of claim 15, wherein the estimation of current in the respective balancing leg is based at least in part on a characteristic impedance of the respective balancing leg.

17. A method, comprising:
modulating at least one switch mode divider (SMD) associated with respective battery cells connected in series to equalize voltage among the battery cells, the SMD characterized by being driven by a constant period signal having an ON time and OFF time, the sum of which equals to a total constant period; and
limiting current in at least one balancing leg associated with the at least one SMD to satisfy a threshold.

18. The method of claim 17, wherein balancing is executed only after at least one battery cell reaches full charge voltage during battery charge.

19. The method of claim 17, comprising limiting current in at least one balancing leg associated with the at least one SMD to satisfy a threshold at least in part using a current sensor that provides input to a controller, and comprising using the controller to modulate the SMD to limit current in the at least one balancing leg to a threshold based on the input from the current sensor.

20. The method of claim 17, comprising limiting current in at least one balancing leg associated with the at least one SMD to satisfy a threshold during battery discharge.

21. An assembly, comprising:
a voltage sensor;
at least one switch mode divider (SMD) connectable to a junction between two battery cells connected in series, and operable to determine voltages from said voltage sensor and equalize voltages between plural cells during charging or discharging of the cells; and
at least one current sensor on a balancing leg associated with the at least one SMD to enable the SMD to limit current from the SMD to at least one of the cells during charging or discharging.

22. The assembly of claim 21, comprising the battery cells, the battery cells comprising Lithium-ion cells.

23. A method, comprising:
modulating at least one switch mode divider (SMD) associated with respective battery cells to equalize voltage between the cells during battery charge or discharge; and
limiting current in at least one balancing leg associated with the at least one SMD to satisfy a threshold.

24. The method of claim 23, wherein at least the balancing is executed only after at least one cell reaches full charge voltage during battery charge.

25. The method of claim 23, comprising limiting current in at least one balancing leg associated with the at least one SMD to satisfy a threshold at least in part using a current sensor providing input to a controller and using the controller to modulate the SMD to limit current in the at least one balancing leg to a threshold based on the input from the current sensor.

26. The method of claim 23, comprising limiting current in at least one balancing leg associated with the at least one SMD to satisfy a threshold during battery discharge.

27. The method of claim 17, comprising recalibrating by periodic application of reference currents on a primary charge path to the cells when the battery is otherwise unloaded and not being charged.

28. The method of claim 17, comprising turning on balancing prior to any cell reaching full charge voltage.
